(19) United States
(12) Patent Application Publication
(10) Pub. No.: US 2010/0046746 A1
(43) Pub. Date: Feb. 25, 2010

(54) PARAMETER GENERATING DEVICE AND CRYPTOGRAPHIC PROCESSING SYSTEM

(75) Inventors: Tomoko YONEMURA, Kanagawa (JP); Hirofumi Muratani, Kanagawa (JP); Atsushi Shimbo, Tokyo (JP); Kenji Ohkuma, Kanagawa (JP); Taichi Isogai, Tokyo (JP); Yuichi Komano, Kanagawa (JP); Kenichiro Furuta, Tokyo (JP); Yoshikazu Hanatani, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/407,475

(22) Filed: Mar. 19, 2009

(30) Foreign Application Priority Data
Aug. 25, 2008 (JP) 2008-216017

(51) Int. Cl. H04L 9/30; H04L 9/00

(52) U.S. Cl. 380/30; 380/255

(57) ABSTRACT

A parameter generating device includes an input receiving unit that receives a degree n of an algebraic torus T including a group G in which a cryptosystem used in a torus-compressed public key cryptosystem is defined, a size W of a finite field F, and a size S of the group G, an extension-degree determining unit that determines an extension degree m of a finite field Fp^{m} in which the algebraic torus T is defined, a first prime-number search unit that searches for a prime number p, a second prime-number search unit that searches for a prime number q, a test unit that checks whether a multiplication value nm is divisible by the prime number q, a security determining unit that determines that the cryptosystem is secure based on the multiplication value nm, and an output unit that outputs parameters when it is determined that the cryptosystem is secure.

### CROSS-REFERENCE TO RELATED APPLICATIONS

This application is based upon and claims the benefit of priority from the prior Japanese Patent Application No. 2008-216017, filed on Aug. 25, 2008; the entire contents of which are incorporated herein by reference.

### BACKGROUND OF THE INVENTION

1. Field of the Invention

The present invention relates to a parameter generating device that generates a parameter for encrypting data according to a public key cryptosystem in which a discrete logarithm problem is set as a basis of security, and a cryptographic processing system including the parameter generating device.

2. Description of the Related Art

The public key cryptosystem that realizes safe communications without sharing a key in advance has been widely used as a fundamental technology for network security. Further, diversification of information terminals has been advanced, and various schemes and protocols using a public key have been used even in a small device by designing a system and implementation.

In the public key cryptosystem, a current typical cryptosystem size is 1024 bits. However, the cryptosystem size, for which decoding is difficult, has been increasing year after year. This is because attacker's abilities to intercept communications are also improving with the advancement of computers. In the public key cryptosystem, the public key size and encrypted data size become several times the size of the cryptosystem (different for each system). Therefore, increase of the cryptosystem size becomes a problem for the device not having sufficient memory capacity and communication band.

Therefore, compression and cryptography techniques for compressing the public key size and the encrypted data size in the public key cryptosystem have been designed (for example, see “A practical public key cryptosystem provably secure against adaptive chosen ciphertext attack” by R. Cramer and V. Shoup, CRYPTO '98, LNCS 1462, pp. 13-25, 1998). This method is based on a fact that elements of a set can be expressed with a small number of bits by using a subset referred to as an algebraic torus among the sets of numbers used in the public key cryptosystem. In the compression and cryptography techniques, an improvement to increase a compressibility (that is, number of bits before compression/number of bits after compression) is made, and an additional input is used for converting the elements of the set to a representation of a small number of bits (for example, see “Torus-Based Cryptography” by K. Rubin and A. Silverberg, CRYPTO 2003, LNCS 2729, 349-365, 2003). A map for conversion to the representation using the small number of bits is referred to as compression map ρ and compression map θ, which are referred to as RS compression map and DW compression map, respectively.

When the encrypted data is to be compressed, in the RS compression map ρ, encrypted data c is used as an input to perform calculation as shown in the equation below, thereby obtaining a compressed encrypted data γ.

ρ(c)=γ

Further, in the DW compression map θ, when the encrypted data c is provided as an input, the following calculation is performed by using an appropriate auxiliary input a1, thereby obtaining the compressed encrypted data γ and an auxiliary output a2.

θ(c, a1)=(γ, a2)

When the compressed encrypted data is to be returned to the original representation using the number of bits, inverse maps of ρ and θ are applied to (γ, a2). The inverse map of the compression map ρ is described as ρ⁻¹, and the inverse map of the compression map θ is described as θ⁻¹, which are referred to as RS decompression map, and DW decompression map, respectively. In the RS decompression map, calculation as shown in the following equation is performed when γ is provided as the compressed encrypted data, thereby obtaining c.

ρ⁻¹(γ)=c

In the DW decompression map, calculation as shown in the following equation is performed when a set of γ and a2 is provided as the compressed encrypted data, thereby obtaining c and a1.

θ⁻¹(γ, a2)=(c, a1)

Compression and decompression using the algebraic torus can be applied not only to the public key and the encrypted data in the public key cryptosystem, but also to a signature in a digital signature and an exchanged message in a key exchange scheme.

The Cramer-Shoup cryptosystem is proposed in “A practical public key cryptosystem provably secure against adaptive chosen ciphertext attack”. The Cramer-Shoup cryptosystem is a system provably secure in a standard model; however, it has a feature that the number of components of the public key and the encrypted data is large. Specifically, encrypted data of the Cramer-Shoup cryptosystem includes four components (c1, c2, c3, c4). The public key also includes four components (g~, e, f, h). Further, there is a problem that respective components are expressed in a representation larger than a group actually used in the cryptography. That is, the Cramer-Shoup cryptosystem is defined on a subgroup G of a prime order of a finite group G~, however, the components of the public key and the encrypted data are expressed in a representation of G~. Specifically, the Cramer-Shoup cryptosystem is defined by the prime order subgroup of a multiplicative group of a prime field. However, the components of the public key and the encrypted data are expressed in a representation of the prime field.

In the Cramer-Shoup cryptosystem and other public key cryptosystems, the group G, which is a subgroup of the finite group G~ and is actually used in the cryptography, is designated as a subgroup of the algebraic torus T, thereby expressing the public key and the encrypted data not in the size of the finite group G~, but in the size of the algebraic torus T. The algebraic torus T is assumed to be a subgroup of the finite group G~.

For example, as disclosed in “Torus-Based Cryptography” and “Asymptotically Optimal Communication for Torus-Based Cryptography” by M. van Dijk and D. Woodruff, CRYPTO 2004, LNCS 3152, 157-178, 2004, the ElGamal cryptosystem and DH key exchange using the algebraic torus on the prime field have been proposed. When T is the torus on the prime field, a smaller torus, which becomes a subgroup of T, is not present. At this time, G~ is assumed to be the multiplicative group of an extension field F. When the subgroup G is selected, it is indicated that the order of G evenly divides the order of T, and the order of G does not evenly divide an extension degree of F.

However, for the public key cryptosystem using the algebraic torus on the extension field, appropriate parameter selection has not been known. Therefore, it can be considered to directly apply a selection method of the parameter for the algebraic torus on the prime field to the public key cryptosystem which uses the algebraic torus on the extension field.

According to this method, however, a case that the subgroup G is included in an extension field smaller than the extension field F cannot be excluded, thereby causing a problem that the appropriate parameter cannot be selected.

### SUMMARY OF THE INVENTION

According to one aspect of the present invention, a parameter generating device includes an input receiving unit that receives an input of a degree n of an algebraic torus T including a group G in which a cryptosystem used in a torus-compressed public key cryptosystem is defined, a size W of a finite field F defining security, and a size S of the group G, an extension-degree determining unit that determines an extension degree m of a finite field Fp^{m} in which the algebraic torus T is defined, a first prime-number search unit that searches for a prime number p having number of bits based on the size W of the finite field F, the degree n of the algebraic torus T, and the extension degree m, a second prime-number search unit that searches for a prime number q having number of bits defined based on the size S of the group G, which evenly divides a cyclotomic polynomial Φₙₘ(p), a test unit that checks whether a multiplication value nm obtained by multiplying the degree n of the algebraic torus T by the extension degree m of the finite field Fp^{m} is divisible by the prime number q, a security determining unit that determines that the cryptosystem is secure when the multiplication value nm is not divisible by the prime number q, and an output unit that outputs parameters (p, q, n, m) including the prime number p, the prime number q, the degree n of the algebraic torus T, and the extension degree m, when it is determined that the cryptosystem is secure.

According to another aspect of the present invention, a cryptographic processing system includes a parameter generating device, a key generating device, an encrypting device, and a decrypting device connected to the encrypting device by a network. The parameter generating device includes a first input-receiving unit that receives an input of a degree n of an algebraic torus T including a group G in which a cryptosystem used in a torus-compressed public key cryptosystem is defined, a size W of a finite field F defining security, and a size S of the group G, an extension-degree determining unit that determines an extension degree m of a finite field Fp^{m} in which the algebraic torus T is defined, a first prime-number search unit that searches for a prime number p having number of bits based on the size W of the finite field F, the degree n of the algebraic torus T, and the extension degree m, a second prime-number search unit that searches for a prime number q having number of bits defined based on the size S of the group G, which evenly divides a cyclotomic polynomial Φₙₘ(p), a test unit that checks whether a multiplication value nm obtained by multiplying the degree n of the algebraic torus T by the extension degree m of the finite field Fp^{m} is divisible by the prime number q, a first security-determining unit that determines that the cryptosystem is secure when the multiplication value nm is not divisible by the prime number q, and a first output unit that outputs parameters (p, q, n, m) including the prime number p, the prime number q, the degree n of the algebraic torus T, and the extension degree m, when it is determined that the cryptosystem is secure. The key generating device includes a second input-receiving unit that receives an input of the parameters (p, q, n, m), a public-key calculating unit that designates the prime number q as an order of the group G and the prime number p as a characteristic of the finite field F, thereby calculating a public key by a combination of operations on the finite field Fp^{m} having the characteristic p and the extension degree m or on a subfield thereof, and a second output unit that outputs the public key. The encrypting device includes a third input-receiving unit that receives an input of the public key and a plain data, an encryption processor that performs an encryption process using the public key with respect to the plain data, by a combination of operations on the finite field Fp^{m} having the characteristic p and the extension degree m or on the subfield thereof, to obtain encrypted data, and a transmitting unit that transmits the encrypted data to the decrypting device. The decrypting device includes a storage unit that stores a secret key, a receiving unit that receives the encrypted data, a decryption processor that performs a decryption process using the secret key with respect to the encrypted data by a combination of operations on the finite field Fp^{m} having the characteristic p and the extension degree m or on the subfield thereof, to obtain the plain data, and a fourth output unit that outputs the plain data.

### BRIEF DESCRIPTION OF THE DRAWINGS

FIG. 1 is a block diagram of a configuration of a cryptographic processing system according to a first embodiment of the present invention;

FIG. 2 is a block diagram of a functional configuration of a parameter generating device according to the first embodiment;

FIG. 3 is a block diagram of a functional configuration of a key generating device according to the first embodiment;

FIG. 4 is a block diagram of a functional configuration of an encrypting device according to the first embodiment;

FIG. 5 is a schematic diagram for explaining an encryption process procedure and a decryption process procedure in the Cramer-Shoup cryptosystem;

FIG. 6 is a block diagram of a functional configuration of a decrypting device according to the first embodiment;

FIG. 7 is a flowchart of a parameter process procedure according to the first embodiment;

FIG. 8 is a flowchart of a parameter-generation process procedure according to a first modification of the first embodiment;

FIG. 9 is a flowchart of a parameter-generation process procedure according to a second modification of the first embodiment;

FIG. 10 is a flowchart of a parameter-generation process procedure according to a third modification of the first embodiment;

FIG. 11 is a flowchart of a key-generation process procedure according to the first embodiment;

FIG. 12 is a flowchart of an encryption process procedure according to the first embodiment;

FIG. 13 is a flowchart of a decryption process procedure according to the first embodiment;

FIG. 14 is a flowchart of a key-generation process procedure according to a fourth modification of the first embodiment;

FIG. 15 is a flowchart of a decryption process procedure according to a fifth modification of the first embodiment;

FIG. 16 is a block diagram of a configuration of a cryptographic processing system according to a second embodiment of the present invention;

FIG. 17 is a block diagram of a functional configuration of a key generating device according to the second embodiment;

FIG. 18 is a block diagram of a functional configuration of an encrypting device;

FIG. 19 is a flowchart of a key-generation process procedure according to the second embodiment;

FIG. 20 is a flowchart of an encryption process procedure according to the second embodiment;

FIG. 21 is a block diagram of a configuration of a cryptographic processing system according to a third embodiment of the present invention;

FIG. 22 is a block diagram of a functional configuration of a parameter generating device according to the third embodiment;

FIG. 23 is a flowchart of a parameter-generation process procedure according to the third embodiment;

FIG. 24 is a flowchart of a parameter-generation process procedure according to a first modification of the third embodiment;

FIG. 25 is a flowchart of a parameter-generation process procedure according to a second modification of the third embodiment;

FIG. 26 is a flowchart of a parameter-generation process procedure according to a third modification of the third embodiment;

FIG. 27 is a block diagram of a configuration of a cryptographic processing system according to a fourth embodiment of the present invention;

FIG. 28 is a block diagram of a functional configuration of a security determining device;

FIG. 29 is a flowchart of a security-determination process procedure according to the fourth embodiment;

FIG. 30 is a flowchart of a security-determination process procedure according to a first modification of the fourth embodiment;

FIG. 31 is a flowchart of a security-determination process procedure according to a second modification of the fourth embodiment;

FIG. 32 is a block diagram of a configuration of a cryptographic processing system according to a fifth embodiment of the present invention;

FIG. 33 is a block diagram of a functional configuration of a key generating device according to the fifth embodiment; and

FIG. 34 is a flowchart of a key-generation process procedure according to the fifth embodiment.

### DETAILED DESCRIPTION OF THE INVENTION

Exemplary embodiments of a parameter generating device, and a cryptographic processing system according to the present invention will be explained below in detail with reference to the accompanying drawings.

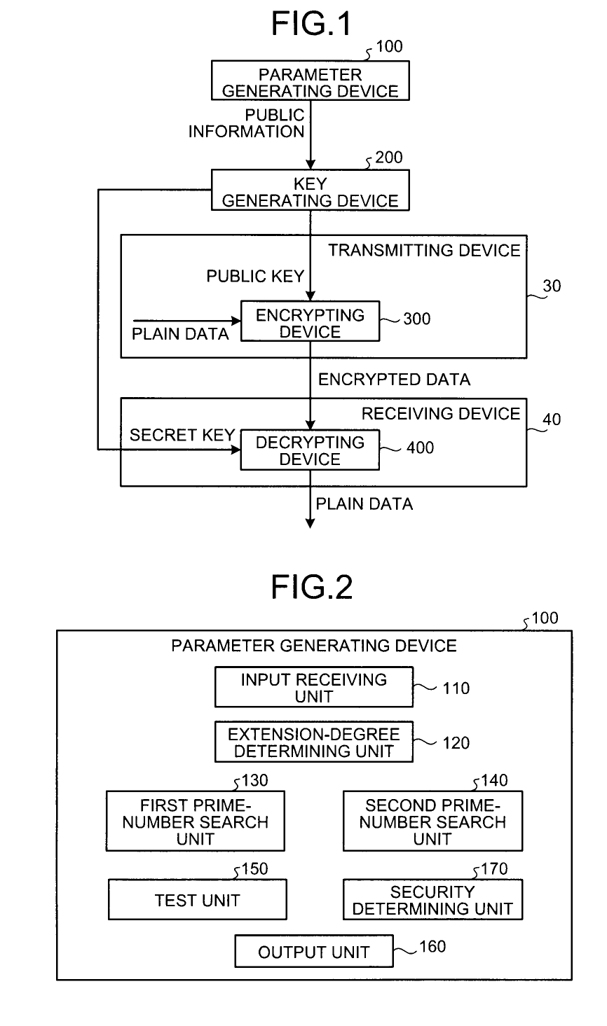

FIG. 1 is a block diagram of a configuration of a cryptographic processing system according to a first embodiment of the present invention. As shown in FIG. 1, the cryptographic processing system according to the first embodiment includes a parameter generating device 100, a key generating device 200, a transmitting device 30, and a receiving device 40. The transmitting device 30 includes an encrypting device 300, and the receiving device 40 includes a decrypting device 400.

The parameter generating device 100 generates a parameter as public information relating to public key cryptosystem. As the parameter, pieces of information of the order or a generating element are included as information of elements of the group and a hash function or information of the group in which the cryptosystem is defined. Details of the configuration of the parameter generating device 100 will be described later.

The key generating device 200 generates a public key and a secret key corresponding to the public key by using the parameter (public information) generated by the parameter generating device 100. Details of the configuration of the key generating device 200 will be described later.

The public key generated by the key generating device 200 and plain data to be encrypted are input to the transmitting device 30 having the encrypting device 300. The plain data can be stored in advance in the transmitting device 30, can be generated by the transmitting device 30, can be sent from another communication device, or can be read from a recording medium.

The encrypting device 300 encrypts the plain data by using the public key to generate encrypted data, and transmits the generated encrypted data to the receiving device 40. Details of the configuration of the encrypting device 300 will be described later.

Upon reception of the encrypted data, the receiving device 40 having the decrypting device 400 decrypts the encrypted data by using the secret key corresponding to the public key used for encryption of the encrypted data, to obtain the plain data. Details of the configuration of the decrypting device 400 will be described later.

The transmitting device 30 and the receiving device 40 can be personal computers (PC), respectively, connected with each other via a network (not shown) such as the Internet.

The encrypting device 300 and the decrypting device 400 use the Cramer-Shoup cryptosystem as an encryption method. The applicable encryption method is not limited thereto, and any method can be applied so long as the encryption method is based on a discrete logarithm problem on a finite field such as the ElGamal cryptosystem.

In the first embodiment, a configuration in which the encrypting device 300 and the decrypting device 400 are respectively included in the transmitting device 30 and the receiving device 40 is explained as an example; however, the configuration of device is not limited thereto. For example, the encrypting device 300 and the decrypting device 400 can be included in a device other than the transmitting device 30 and the receiving device 40. The encrypting device 300 and the decrypting device 400 can be included in the same device.

The parameter generating device 100 according to the first embodiment is explained first. A principle of the parameter generation in the first embodiment is explained below.

The field is a set of numbers in which four arithmetic operations are defined, and when the set of numbers is finite, the field is referred to as a finite field. It is known that the number of numbers included in the finite field is a prime number or a power of the prime number. A field in which the number of numbers is the prime number is referred to as the prime field, and a field in which the number of numbers is the power of the prime number is referred to as the extension field. The prime number which determines the number of elements of the prime field and the extension field is referred to as a characteristic, and the power thereof is referred to as an extension degree.

The multiplicative group is a set of numbers in which multiplication and division are defined, and it is known that the multiplicative group is obtained by excluding 0 from the elements of the finite field. The number of elements of the group is referred to as the order.

When T is assumed to be the algebraic torus on the extension field, there is a smaller torus, which becomes a subgroup of T. When G~ is assumed to be the multiplicative group of the extension field F, a torus t, which is not included in a true subfield of the extension field F is determined from the smaller tori, and a degree thereof becomes the degree of the extension field. Because t is a subgroup of T, if the cryptosystem is defined on the prime order subgroup of t, the public key and the encrypted data are expressed in the size of T. The degree of T that can constitute a compression and decompression map is determined, and the degree and the characteristic of the extension field in which T is defined are determined based on security requirements.

If the group G is included in the true subfield F′ of the extension field F, the size of F′ determines the security of G. That is, the security decreases by a difference of the size. When F=F′ (that is, when G is the subgroup of t), the cryptosystem is defined on the prime order subgroup G of T, without decreasing the security of the original F.

On the other hand, even if F>F′, if F′ has a sufficient size, compression is performed at a compressibility (size of F′/size of T) lower than the maximum compressibility (that is, size of F/size of T) of the algebraic torus T. The principle of the parameter generation method in which F=F′ is explained below in detail.

Consider defining the public key cryptosystem on the group G having the security determined by the extension field F. It is also assumed that the multiplicative group of the extension field F is G~, and the algebraic torus, which is the subgroup thereof, is T. Further, G is the prime order subgroup of the algebraic torus T. As the set thereof, a specific set described below is taken into consideration.

1) The extension field F is an nm-th extension field of a characteristic p, where p is a prime number, n and m are positive integers, and the order (the number of elements) of F is p^{nm}. That is, the extension field F is expressed by equation (1).

F=Fp^{nm} (1)

2) The order of the multiplicative group G~ of the extension field F is p^{nm}−1. This is shown by equation (2).

G~=F*p^{nm},# F*p^{nm}=p^{nm}−1 (2)

In the equation (2), # X indicates the order of group X.

3) The algebraic torus T, which is the subgroup of the multiplicative group G~ of the extension field F, is assumed to be the algebraic torus of degree n defined on the m-th extension field of the character p. The order of the algebraic torus T is Φₙ(p^{m}), where Φₙ(x) is the nth cyclotomic polynomial. This is shown by equation (3).

T ⊂ G~, T=Tₙ(Fp^{nm}), # Tₙ(Fp^{nm})=Φₙ(p^{m}) (3)

4) In the order of the prime order subgroup G of the algebraic torus T, q should be a prime number that evenly divides Φₙₘ(p) from a security point of view. This is shown by equation (4).

G ⊂ T, # G=q, q|Φₙₘ(p) (4)

The prime order subgroup G of the algebraic torus T, the algebraic torus T, the multiplicative group G~ of the extension field F, and the extension field F are uniquely determined by parameters (p, q, m, n), which are public information. At this time, p is a characteristic of the extension field F, q is the order of the prime order subgroup G, m is the degree of an extension field Fp^{m} in which the algebraic torus T is defined, and n is the degree of the algebraic torus T. When the smallest extension field including the prime order subgroup G of the algebraic torus T is designated as F′, the order of p of mod q is the extension degree of the extension field F′. The extension degree of the extension field F′ is the smallest x satisfying q|(p^{x}−1), and this relational expression is rewritten as in equation (5).

p^{x}≡1(mod q) (5)

This result is obtained by reconsidering an argument relating to an embedding degree of an elliptic curve on the extension field described in “On the minimal embedding field” by Laura Hitt, Pairing 2007, LNCS 4575, pp. 294-301, 2007. When the order of p of mod q is described as ord(q, p), F′=F has the same value as ord(q, p)=nm. Further, ord(q, p)=nm has the same value as that of equation (6).

q|(p^{nm}−1) and ∀d|nm, d≠nm, q [symbol] (p^{d}−1) (6)

Because p^{nm}−1 is broken down by a product of the cyclotomic polynomial Φ_{d}(p) of d|nm, it is derived that the equation (6) has the same value as equation (7).

q|Φₙₘ(p) and ∀d|d|nm, d≠nm, q [symbol] Φ_{d}(p) (7)

It is proven that the extension degree of the extension field F′ becomes a divisor of nm from a fact that x is the smallest x satisfying q|(p^{x}−1). Further, as described in “Looking beyond XTR” by W. Bosma, J. Hutton, and E. R. Verheul, Asiacrypt '02, LNCS 2501, pp. 46-63, 2002, when q does not evenly divide nm, a polynomial (X^{nm}−1) of mod q does not have a multiple root. In this case, therefore, conditions in the equations (6) and (7) after “and” are established automatically. Further, it has been found that if a property of the cyclotomic polynomial is used for the order of the algebraic torus T on the extension field, the order is expressed in equation (8), where mₙ is a factor of m and is a product of all prime factors of n, and m~ₙ is m/mₙ.

$${Φ}_{n} ( {p}^{m} ) = {\prod }_{{d}^{′} {m}_{n}^{\sim}} {Φ}_{n {m}_{n} d} ( p ) \qquad ( 8 )$$

The parameter generating device 100 according to the first embodiment efficiently generates secure and operation-friendly parameters (p, q, m, n) using the equation (8).

FIG. 2 is a block diagram of a functional configuration of the parameter generating device 100 of the first embodiment. As shown in FIG. 2, the parameter generating device 100 mainly includes an input receiving unit 110, an extension-degree determining unit 120, a first prime-number search unit 130, a second prime-number search unit 140, a test unit 150, an output unit 160, and a security determining unit 170.

The input receiving unit 110 receives an input of the degree n of the algebraic torus T, the size W of the extension field F, and the size S of the prime order subgroup G of the algebraic torus T. The extension-degree determining unit 120 determines an extension degree m of the extension field F.

A group used in a torus-compressed Cramer-Shoup cryptosystem is uniquely determined by the parameters (p, q, m, n). At this time, p is the characteristic of the extension field, q is the order of the prime order subgroup, m is the degree of the extension field in which the algebraic torus T is defined, and n is the degree of algebraic torus. In the first embodiment, the parameters (p, q, m, n) satisfying both of a condition 1 in equation (9-1) and a condition 2 in equation (9-2) set based on the equation (7) are searched.

Condition 1: Φₙₘ(p)≡0(mod q) (9-1)

Condition2 : q [symbol] nm (9-2)

The condition 1 is a condition for including the prime order subgroup G in the algebraic torus of the degree nm in the subgroups of the algebraic torus T. Prime numbers p and q satisfying the condition 1 are respectively searched by the first prime-number search unit 130 and the second prime-number search unit 140.

That is, the first prime-number search unit 130 searches for the prime number p having the number of bits based on the size W of the extension field F, the degree n of the algebraic torus T, and the extension degree m. Specifically, the first prime-number search unit 130 searches for the prime number p having the number of bits equal to or larger than W/nm.

The second prime-number search unit 140 searches for the prime number p that evenly divides a cyclotomic polynomial Φₙₘ(p), and that has the number of bits set based on the size S of the prime order subgroup G. Specifically, the second prime-number search unit 140 searches for the prime number q having the number of bits equal to or larger than S, which evenly divides the cyclotomic polynomial Φₙₘ(p).

The condition 2 in the equation (9-2) is a condition such that the prime order subgroup G is included in only one subgroup of the subgroups of the algebraic torus T. The test unit 150 checks whether m determined by the extension-degree determining unit 120, prime number p searched by the first prime-number search unit 130, and prime number q searched by the second prime-number search unit 140 satisfy the condition 2. That is, the test unit 150 checks whether a multiplication value nm obtained by multiplying the degree n of the algebraic torus T and the extension degree m of the finite field Fp^{m} can be divided evenly by the prime number q. When the condition 2 is not satisfied, determination of m and search of p and q are performed again.

As the condition 2, equation (10) can be used instead of the equation (9-2).

Condition 2: Φ_{d}(p)≠0(mod q) (10)

where, every d of d|nm and d<nm

where d is a divisor of nm. The condition of the equation (10) is a necessary and sufficient condition of ord(q, p)=nm. However, in the equation (10), because every d needs to be checked, a method of determining the condition of the equation (9-2) has an advantage that the test time can be reduced.

The security determining unit 170 determines that the cryptosystem is secure when the test unit 150 recognizes that the multiplication value nm is not divisible by the prime number q.

The output unit 160 determines that the cryptosystem is secure when nm is not divisible by the prime number q, and outputs the parameters (p, q, m, n) including the prime number p, the prime number q, the extension degree m, and the degree n of the algebraic torus.

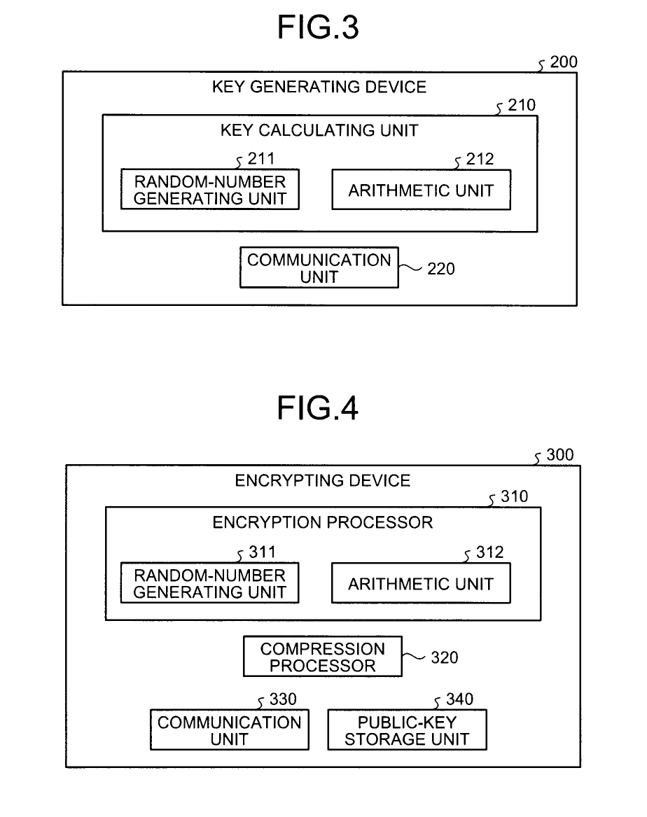

The key generating device 200 is explained next. FIG. 3 is a block diagram of a functional configuration of the key generating device 200 according to the first embodiment. As shown in FIG. 3, the key generating device 200 mainly includes a key calculating unit 210 and a communication unit 220.

The key calculating unit 210 inputs the parameters (p, q, m, n) generated by the parameter generating device 100 to generate the public key and the secret key. The key calculating unit 210 includes a random-number generating unit 211 and an arithmetic unit 212.

The random-number generating unit 211 generates a random number whose range is limited by the order q of the prime order subgroup G. The arithmetic unit 212 generates the secret key. The arithmetic unit 212 inputs a generating element g of the prime order subgroup G and performs an exponentiation and multiplication by using the generated random number with respect to the generating element g of the prime order subgroup G on the extension field having the characteristic p and the extension degree m or the subfield thereof, thereby obtaining an operation result as the public key.

In a key generation process in the Cramer-Shoup cryptosystem, the exponentiation and multiplication are performed on the prime field; however, in the key generation process in the torus-compressed Cramer-Shoup cryptosystem, the exponentiation and multiplication are performed on the extension field. It is an operation of the extension degree nm of the characteristic p on the extension field; however, because n is the degree of the algebraic torus and m is the extension degree of the extension field in which the algebraic torus is defined, it is calculation of a vector including n elements of the extension field Fp^{m}. Because the compression and decompression map and the operation on the algebraic torus use the operation on the extension field Fp^{m}, the same arithmetic processing can be used and efficient operation can be performed.

The multiplication and addition on the extension field Fp^{m} do not need to be performed consecutively, and conversion of vector representation, and a modulus polynomial and a base of the nth extension are not required, so long as the representation of the extension field is agreed beforehand.

The communication unit 220 transmits the generated secret key and public key to the encrypting device 300 and the decrypting device 400 via the network.

The encrypting device 300 is explained next. FIG. 4 is a block diagram of a functional configuration of the encrypting device 300 according to the first embodiment. The encrypting device 300 includes, as shown in FIG. 4, an encryption processor 310, a compression processor 320, a communication unit 330, and a public-key storage unit 340.

The encryption processor 310 performs an encryption process using the public key with respect to plain data, by a combination of operations on the extension field F having the characteristic p and the extension degree m or on the subfield thereof, to obtain the encrypted data.

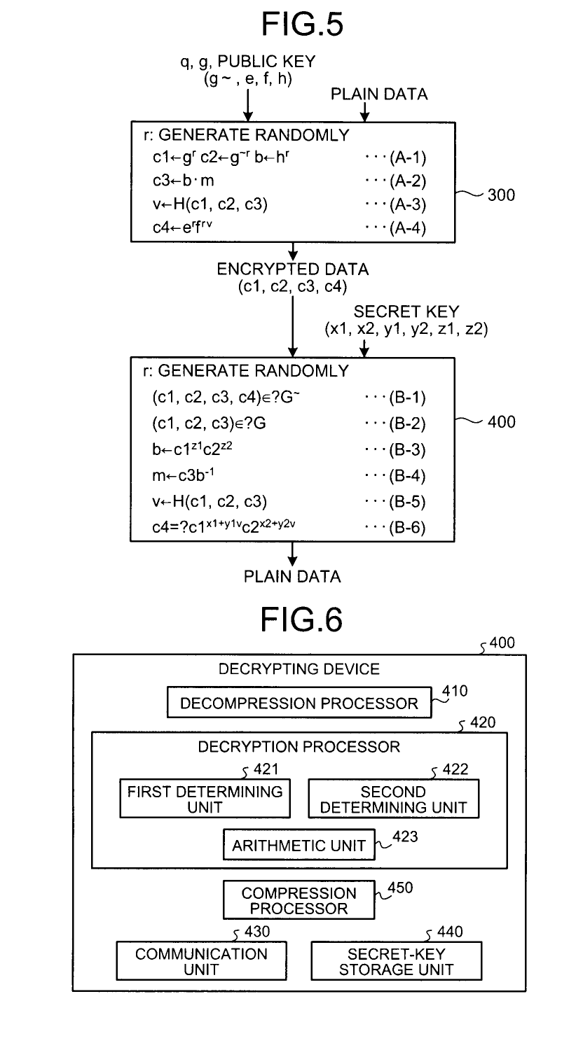

The Cramer-Shoup cryptosystem method is explained below. FIG. 5 is a schematic diagram for explaining an encryption process procedure and a decryption process procedure in the Cramer-Shoup cryptosystem. In FIG. 5, reference letter q denotes the prime number, g denotes the generating element of group G (the order is q) in which a cipher is defined, and g~, e, f, and h denote elements of group G. Plain data m is also the element of G. Reference letter r denotes a random number generated randomly.

As shown in FIG. 4, a specific encryption process of the Cramer-Shoup cryptosystem includes calculation of exponentiation and multiplication of random power, and calculation of a hash function.

The encryption processor 310 calculates encrypted data (c1, c2, c3, c4) corresponding to plain data m according to equations (A-1) to (A-4). Reference letter H in equation (A-3) denotes the hash function, and the encrypted data is input to the hash function H, thereby obtaining a hash value v. The secret key is assumed to be an integer from 1 to q (or integer from 0 to q−1).

Referring back to FIG. 4, the encryption processor 310 includes a random-number generating unit 311 and an arithmetic unit 312 to execute the procedure.

The random-number generating unit 311 generates random number r whose range is limited by the order q of the prime order group G. The arithmetic unit 312 performs a first exponentiation with respect to the generating element g and the public key by using the random number (A-1), multiplies the plain data by a result of the first exponentiation (A-2), to obtain the hash value of a multiplication result and the result of the first exponentiation (A-3), and performs a second exponentiation with respect to the public key by using the hash value and a random number, thereby obtaining the results of the first exponentiation and the second exponentiation as the encrypted data (A-4).

The compression processor 320 performs torus compression with respect to the encrypted data generated by the encryption processor 310 according to the compression map.

In the encryption process and the compression process in the torus-compressed Cramer-Shoup cryptosystem, the exponentiation and multiplication operations are performed on the extension field Fp^{m} having the characteristic p and the extension degree m, or on the subfield thereof.

That is, the encryption process and the compression process are operations on the extension field having the characteristic p and the extension degree nm. However, because n is the degree of the algebraic torus and m is the extension degree of the extension field in which the algebraic torus is defined, it is the calculation of a vector including n elements of the extension field Fp^{m}. Because the compression map and the operation on the algebraic torus use the operation on the extension field Fp^{m}, the same arithmetic processing can be used and efficient operation can be performed.

The multiplication and addition on the extension field F do not need to be performed consecutively, and conversion of vector representation, and the modulus polynomial and the base of the nth extension are not required, so long as the representation of the extension field is agreed beforehand.

The communication unit 330 transfers data with the key generating device 200 and the decrypting device 400. Specifically, the communication unit 330 receives the public key from the key generating device 200. Further, the communication unit 330 transmits the torus-compressed encrypted data to the decrypting device 400. The public-key storage unit 340 is a recording medium for storing the public key sent from the key generating device 200.

The decrypting device 400 is explained next. FIG. 6 is a block diagram of a functional configuration of the decrypting device 400 according to the first embodiment. The decrypting device 400 mainly includes, as shown in FIG. 6, a decompression processor 410, a decryption processor 420, a communication unit 430, a secret-key storage unit 440, and a compression processor 450.

The communication unit 430 receives the secret key from the key generating device 200. The communication unit 430 also receives the compressed encrypted data from the encrypting device 300. The secret-key storage unit 440 is a recording medium for storing the received secret key.

The decompression processor 410 decompresses the compressed encrypted data sent from the encrypting device 300 by using a decompression map on the extension field Fp^{m} having characteristic p and extension degree m, or on the subfield thereof.

The decryption processor 420 decrypts encrypted data by using the secret key, to obtain plain data. Referring back to FIG. 5, the decryption processor 420 checks whether it is the right plain data by using the secret key (x1, x2, y1, y2, z1, z2) and the encrypted data (c1, c2, c3, c4) according to equations (B-1) to (B-6), thereby calculating plain data m. The secret keys (x1, x2, y1, y2, z1, z2) are integers from 1 to q. Further, cΕ^{?}G (or G~) indicates that it is determined whether c belongs to group G (or group G~).

Accordingly, the decryption processor 420 includes a first determining unit 421, a second determining unit 422, and an arithmetic unit 423.

That is, the specific decryption process of the Cramer-Shoup cryptosystem includes test to check whether it is an element of the right group, calculation of the hash function, check of the test equations (exponentiation and multiplication), and calculation of the plain data (inverse element and multiplication).

The first determining unit 421 tests whether the encrypted data is the element of the prime order subgroup G, and when the encrypted data is the element of the prime order subgroup G or the element of the multiplicative group G~ of the extension field F, determines that the encrypted data is valid (B-1, B-2).

The arithmetic unit 423 performs the exponentiation and multiplication with respect to c1 and c2, which are the elements of the encrypted data, on the extension field Fp^{m} having the characteristic p and the extension degree m or on the subfield thereof, to obtain the inverse element and multiplies the inverse element by c3, which is the element of the encrypted data, thereby obtaining plain data m (B-3, B-4).

The second determining unit 422 obtains the hash value of the encrypted data by using the hash function H on the extension field Fp^{m} having the characteristic p and the extension degree m or on the subfield thereof (B-5), and performs the exponentiation and multiplication with respect to c1 and c2, which are the elements of the encrypted data by using the hash value and the secret key. When a result thereof matches c4, which is the element of the encrypted data, the second determining unit 422 determines that the encrypted data is valid (B-6).

The test of whether the encrypted data is the element of the right group according to the equations (B-1) and (B-2) can be executed before the decompression process. In this case, useless calculation of the decompression map can be omitted. When the algebraic torus of the prime order is used, the test in the compressed representation becomes easy and convenient. The calculation of the hash function can be also performed before the decompression process, so long as it is agreed with the decryption processor 420 that a value after compression is used as an input value thereof.

The compression processor 450 performs torus compression with respect to the plain data calculated by the decryption processor 420 according to the operation on the extension field Fp^{m} having the characteristic p and the extension degree m or on the subfield thereof.

The processing from the parameter generation to decryption in the cryptographic processing system according to the first embodiment is explained next.

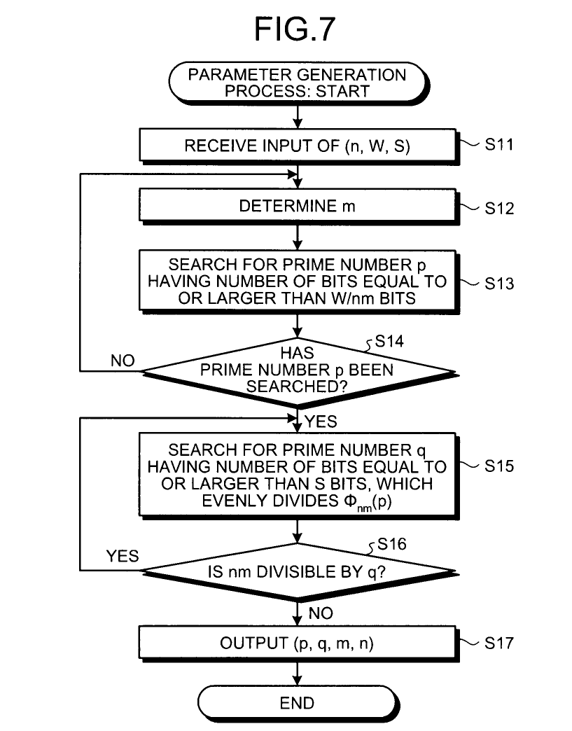

The parameter generation process performed by the parameter generating device 100 is explained first. FIG. 7 is a flowchart of a parameter process procedure according to the first embodiment.

The input receiving unit 110 first receives an input of a set of degree n of the algebraic torus T, the size W of the extension field F, and the size S of the prime order subgroup G (Step S11).

The extension-degree determining unit 120 then determines extension degree m of the extension field F (Step S12). Determination of extension degree m is explained below in detail.

For example, it is assumed that n=6, W=2048, and S=224. As conditions for constituting the extension field Fp^{m}, there can be mentioned that the modulus polynomial of the m-th extension of the prime field Fp is irreducible on the prime field Fp, the modulus polynomial of cubic extension of the m-th extension field Fp^{m} is irreducible on the extension field Fp^{m}, and the modulus polynomial of quadratic extension of the 3m-th extension field Fp^{3m} is irreducible on the extension field Fp^{3m}.

For example, when the modulus polynomial of the m-th, cubic, and quadratic extensions are, respectively, z^{m}−s, y³−w, and x²+1, the sufficient condition for these modulus polynomials being irreducible on the respective fields Fp, Fp^{m}, and Fp^{3m} is that the following four conditions are established simultaneously.
1) m is an odd number;
2) m is divisible by 3, and for p, the remainder after dividing p by 4m is 2m+1; or m is not divisible by 3 and the remainder after dividing p by 12m is 6m+1;
3) s^{(floor(p/m)d)}≠1, d|m, d≠m; and
4) w^{(floor(p/m)×(p̂m-1)/(p-1))}≠1.

The “floor(x)” is a floor function, and is a function that returns the largest integer not exceeding x. Further, p̂x denotes the x-th power of p.

A condition for constituting the prime order torus is that the order of torus T6 (Fp^{m}) is Φ₆(p^{m}), and the necessary condition for the order thereof becoming a prime number is that the following equation is established.

m=2^{a}×3^{b}. 5)

Accordingly, the extension-degree determining unit 120 determines the extension degree m to satisfy the conditions above from 1) to 5).

In another example, when the modulus polynomials of the m-th, cubic, and quadratic extensions are, respectively, z^{m}−s, y³−w, and x²−δ, the necessary and sufficient condition for these modulus polynomials being irreducible on the respective fields Fp, Fp^{m}, and Fp^{3m} is that following five conditions are established simultaneously.
1′) (p−1) is be divisible by a prime factor of m, (p^{m-}1) is divisible by 3, and (p^{3m}−1)is divisible by 2;
2′) If m is divisible by 4, (p−1) is divisible by 4;
3′) s^{(floor(p/P))}≠1; however, P is the prime factor of m;
4′) w^{(floor(p̂m/3))}≠1; and
5) δ^{(floor(p̂(3m)/2))}≠1.

The “floor(x)” is a floor function, and is the function that returns the largest integer not exceeding x.

A condition for constituting the prime order torus is that the order of torus T6 (Fp^{m}) is Φ₆ (p^{m}) , and the necessary condition for the order thereof becoming a prime number is that the following equation is established.

m=2^{a}×3^{b} 6′)

Accordingly, the extension-degree determining unit 120 determines the extension degree m to satisfy the conditions above from 1′) to 6′).

The first prime-number search unit 130 then searches for the prime number p having the number of bits equal to or larger than W/nm (Step S13).

For example, when the modulus polynomials of the m-th, cubic, and quadratic extensions are, respectively, z^{m}−s, y³−w, and x²+1, the first prime-number search unit 130 searches for a prime number satisfying the condition of 2) as the prime number p. When there is a plurality of candidates of m, the search is performed for each candidate. In the above example, because m=27, 81, and 243, m can be divided by 3, and such a prime number that the remainder after dividing p by 4m becomes 2m+1 is searched.

In another example, when the modulus polynomials of the m-th, cubic, and quadratic extensions are, respectively, z^{m}−s, y³−w, and x²−δ, the first prime-number search unit 130 searches for a prime number satisfying the conditions of 1′) and 2′) as the prime number p. When there is a plurality of candidates of m, the search is performed for each candidate. In the above example, because m=18, 24, 27, 32, . . . , such a prime number is searched that when m is divisible by 2, (p−1) is divisible by 2, when m is divisible by 3, (p−1) is divisible by 3, or when m is divisible by 4, (p−1) is divisible by 4, and (p^{m}−1) is divisible by 3 and (p^{3m}−1) is divisible by 2.

Processes at Steps S12 and S13 are repeated until the prime number p is searched (NO at Step S14).

When the prime number p is searched (YES at Step S14), the second prime-number search unit 140 searches for a prime number q having the number of bits equal to or larger than S, which evenly divides Φₘ(p), to satisfy the condition of the equation (9-1) (Step S15).

When the prime number q is searched, the test unit 150 determines whether nm is divisible by the prime number q to determine whether the condition 2 in the equation (9-2) is satisfied (Step S16). When nm is divisible by the prime number q (YES at Step S16), the search of the prime number q at Step S15 is repeated.

On the other hand, at Step S16, when nm is not divisible by the prime number q (NO at Step S16), the security determining unit 170 outputs the parameters (p, q, m, n), determining that the cryptosystem is secure, and the output unit 160 determines that the prime number q satisfying the condition 2 in the equation (9-2) has been searched (Step S17).

As a first modification of the parameter generation process (a first modification of the first embodiment), there is a process in which the prime order torus T itself is used as the prime order subgroup G in which the cryptosystem is defined. In this case, because the order of prime order torus T becomes equal to the order of the prime order subgroup G, Φₙ(p^{m})=q is established. Accordingly, under this condition, a parameter satisfying the conditions 1 and 2 is searched.

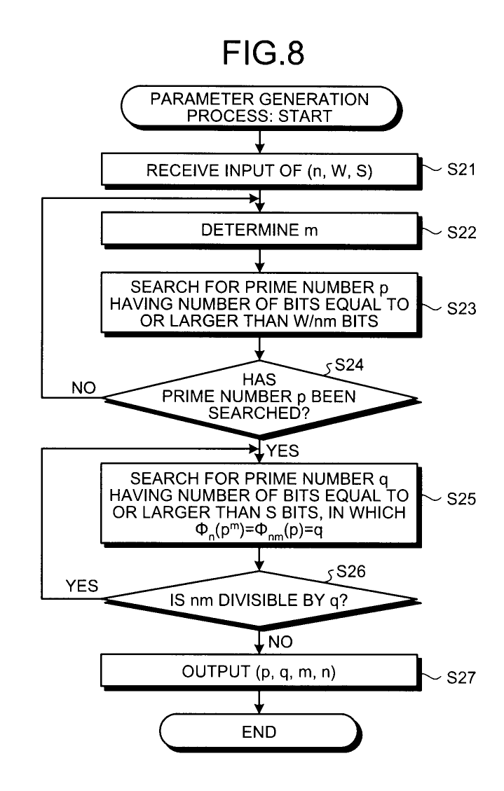

FIG. 8 is a flowchart of a parameter-generation process procedure according to the first modification of the first embodiment. As shown in FIG. 8, in the first modification, a point that the prime number q satisfying Φₙ(p^{m})=Φₙₘ(p)=q is searched, in the search of the prime number q at Step S26, is different from the processes in FIG. 7, and processes at other Steps S21 to S24, S26, and S27 are same as the processes in FIG. 7.

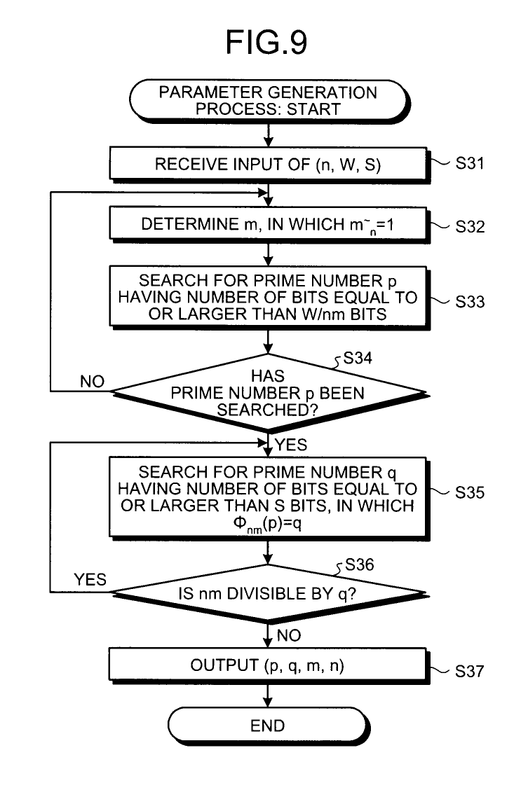

As a second modification of the parameter generation process (a second modification of the first embodiment), the prime number q can be searched according to the condition based on the equation (8). FIG. 9 is a flowchart of the parameter-generation process procedure according to the second modification. In the second modification, because the equation (8) is established for the order of the algebraic torus T, when m~ₙ=1, Φₙ(p^{m})=Φₙₘ(p) is established. Accordingly, at the time of determining the extension degree m of the extension field F at Step S32, a restriction such as m~ₙ=1 is imposed, and the prime number q, which is =Φₙₘ(p)=q, is searched in the search process of the prime number q at Step S35. Accordingly, the test of Φₙ(p^{m})=Φₙₘ(p) at Step S25 in the first modification can be omitted.

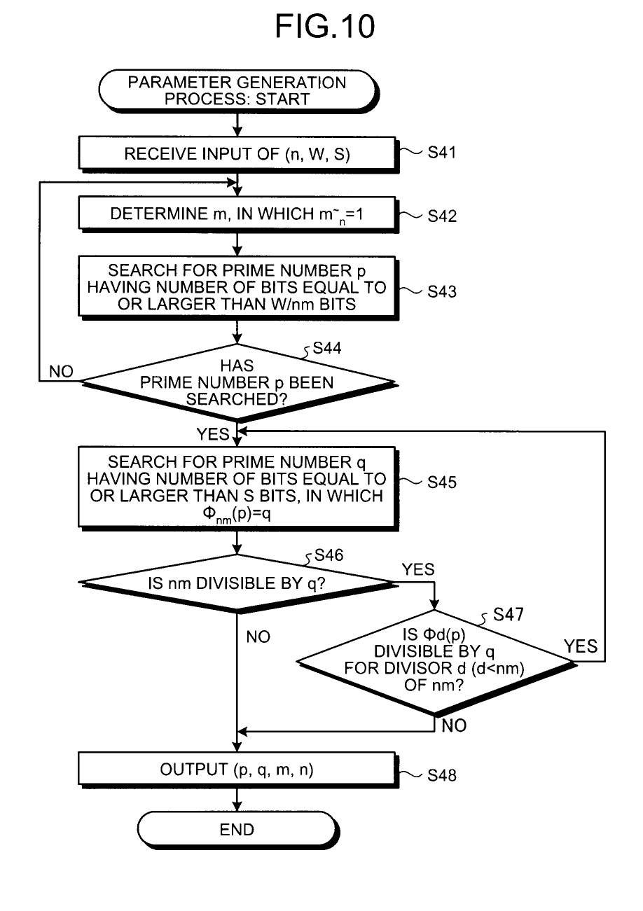

There is a process described below as a third modification of the parameter generation process (a third modification of the first embodiment). FIG. 10 is a flowchart of the parameter-generation process procedure according to the third modification. Even when the condition 2 in the equation (9-2) is not established, as far as the equation (10) is established for every d of d|nm and d<nm, the parameter can be obtained. Reference letter d is the divisor of nm.

Accordingly, in the third modification, at Step S46, when the condition 2 in the equation (9-2) is not established, that is, when nm is divisible by the prime number q (YES at Step S46), determination of the equation (10) is performed, that is, it is determined whether Φd(p) is divisible by q for the divisor d of nm (Step S47). When Φd(p) is not divisible by q (NO at Step S47), the parameters (p, q, m, n) are output even if the condition 2 is not established. On the other hand, when Φd(p) is divisible by q (YES at Step S47), the prime number q is searched again.

Processes at other Steps S41 to S45, S46, and S48 are performed in the same manner as in the second modification. In FIG. 10, an example in which the process at Step S47 is included in the process in the second modification (FIG. 9) is shown; however, the process is not limited thereto, and the process at Step S47 can be included in the process in the first embodiment shown in FIG. 7 or the process in the second modification shown in FIG. 8.

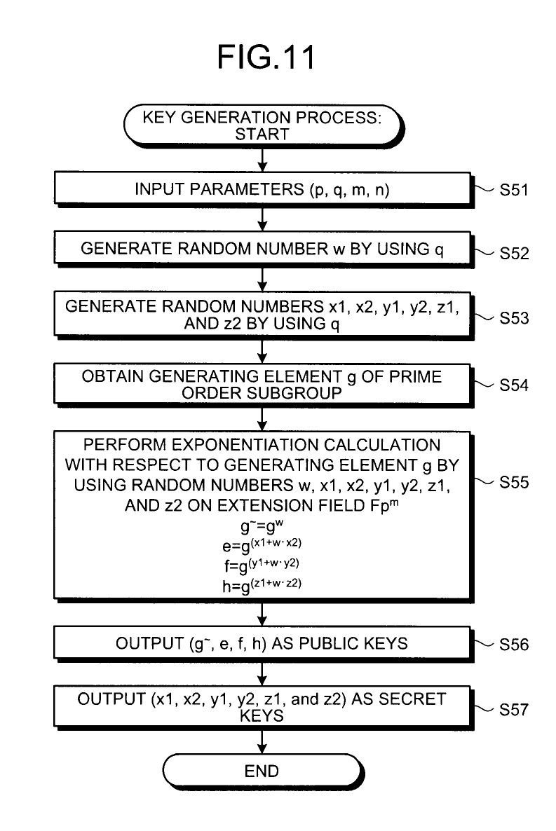

The key generation process performed by the key generating device 200 is explained next. FIG. 11 is a flowchart of a key-generation process procedure according to the first embodiment.

The random-number generating unit 211 first inputs the parameters (p, q, m, n) from the parameter generating device 100 (Step S51), and generates a random number w, which is 0<w<q, by using the order q of the prime order subgroup G among these (Step S52). The random-number generating unit 211 also generates random numbers x1, x2, y1, y2, z1, and z2, which are respectively 0≦x1, x2, y1, y2, z1, z2<q, by using the order q of the prime order subgroup G (Step S53).

The arithmetic unit 212 then obtains a generating element g of the prime order subgroup G (Step S54).

The arithmetic unit 212 then performs the exponentiation in equations (11-1) to (11-4) (Step S55).

g~=g^{w} (11-1)

e=g^{(x1+w·x2)} (11-2)

f=g^{(y1+w·y2)} (11-3)

h=g^{(z1+w·z2)} (11-4)

The output unit 160 outputs calculation results (g~, e, f, h) as the public keys (Step S56), and outputs (x1, x2, y1, y2, z1, z2) as the secret keys (Step S57). More specifically, the output unit 160 transmits the public keys to the encrypting device 300, and transmits the secret keys to the decrypting device 400.

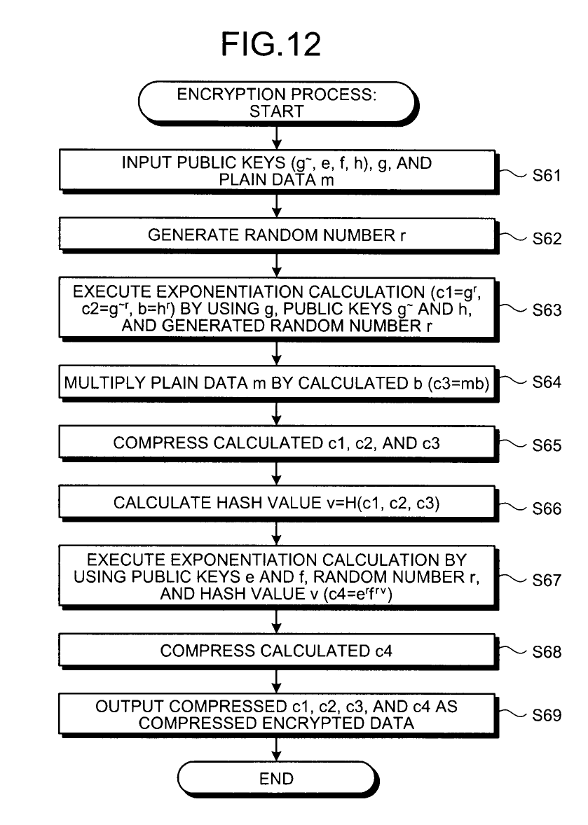

The encryption process performed by the encrypting device 300 is explained next. FIG. 12 is a flowchart of the encryption process procedure according to the first embodiment. Specifically, the calculation process shown in the equations (A-1) to (A-5) in FIG. 5 is performed.

The communication unit 330 inputs the generating element g, the public keys g~, e, f, and h, and the plain data m (Step S61). The random-number generating unit 311 then generates a random number r (Step S62).

The arithmetic unit 312 executes exponentiation calculation of c1=g^{r}, c2=g~^{r}, and b=h^{r} by using the generating element g, the public keys g~and h, and the random number r (Step S63). The arithmetic unit 312 multiplies the plain data m by the calculated b to calculate c3=mb (Step S64).

The compression processor 320 then compresses c1, c2, and c3 by compression map (Step S65).

The arithmetic unit 312 calculates a hash value v=H (c1, c2, and c3) by using c1, c2, and c3 as an input to the hash function H (Step S66). The arithmetic unit 312 executes the exponentiation calculation of c4=e^{r}f^{rv} by using the public keys e and f, the random number r, and the calculated hash value v (Step S67).

The compression processor 320 then compresses c4 by using the compression map (Step S68). Finally, the communication unit 330 outputs compressed (c1, c2, c3, and c4) as the compressed encrypted data (compressed encrypted data) (Step S69), and transmits the data to the decrypting device 400.

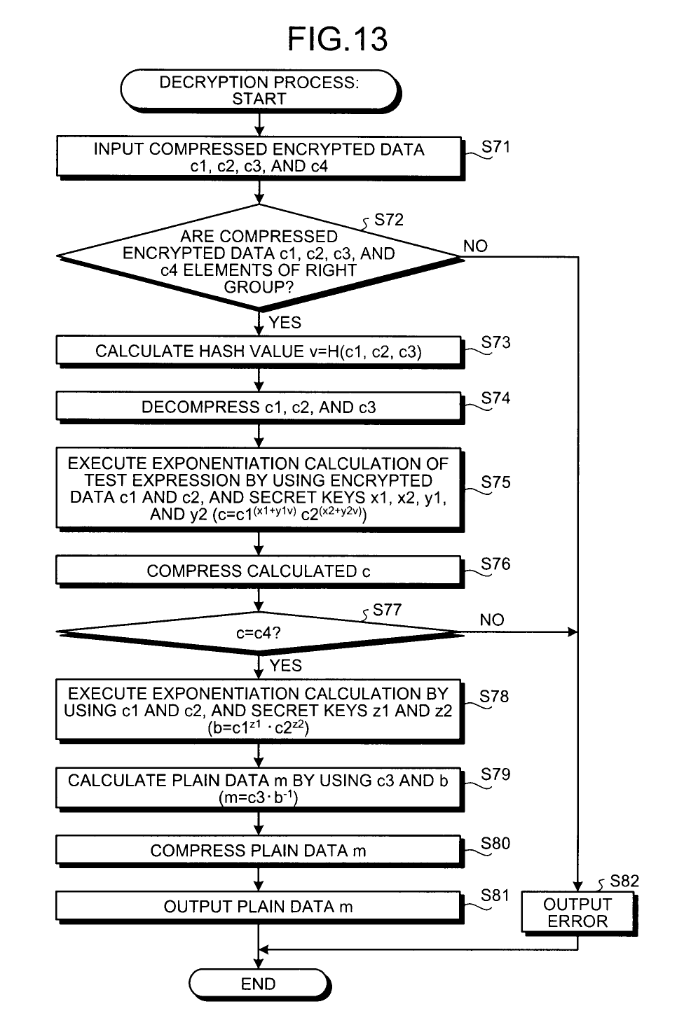

The decryption process performed by the decrypting device 400 is explained next. FIG. 13 is a flowchart of the decryption process procedure according to the first embodiment. Specifically, the calculation of the equations (B-1) to (B-6) in FIG. 5 is performed.

The communication unit 430 first receives the encrypted data (compressed encrypted data) to be decrypted as input (Step S71).

The first determining unit 421 determines whether compressed c1, c2, c3, and c4, which are the components (elements) of the encrypted data, are the right elements of the group, that is, determines whether respective c1, c2, c3, and c4 are the elements of group G (Step S72). Specifically, when respective values of the vector representation (c1, c2, c3, c4), in which the components of the encrypted data are designated as the elements, are in a range from 0 to p−1, the first determining unit 421 can determine that respective encrypted data c1, c2, c3, and c4 are the right elements of the group.

When it is determined that the components of the encrypted data are not the right elements of group G (NO at Step S72), the decryption process is finished.

When it is determined that the components of the encrypted data are the right elements of group G (YES at Step S72), the decompression processor 410 calculates the hash value v=H(c1, c2, c3) by using c1, c2, and c3 as an input to the hash function H (Step S73).

The decompression processor 410 then decompresses the compressed encrypted data c1, c2, and c3 by using the decompression map (Step S74). The arithmetic unit 423 executes the exponentiation calculation of c=c1^{(x1+y1v)}c2^{(x2+y2v)} by using the hash value v, the decompressed encrypted data c1 and c2, and x1, x2, y1, and y2 of the secret keys (Step S75). The arithmetic unit 423 compresses c calculated by the exponentiation calculation (Step S76). The decompression processor 410 decompresses the compressed encrypted data c4.

Next, the second determining unit 422 determines whether c matches c4 of the components of the input encrypted data (Step S77). Specifically, when the respective values in the vector representation of the encrypted data match each other, the second determining unit 422 can determine that c matches the component c4 of the input encrypted data.

When c and c4 do not match each other (NO at Step S77), the decryption process is finished. On the other hand, when c and c4 match each other (YES at Step S77), the arithmetic unit 423 uses c1 and c2, and z1 and z2 of the secret keys to execute the exponentiation calculation of b=c1^{z1}c2^{z2} (Step S78).

The arithmetic unit 423 then calculates plain data m=c3b⁻¹ by using c3 and the calculated b (Step S79). The compression processor 450 compresses the plain data m (Step S80) and outputs the compressed plain data m (Step S81).

As described above, according to the first embodiment, the parameter generating device 100 generates the parameters (p, q, m, n) to satisfy the equations (9-1) and (9-2), and performs the key generation process, the encryption process, and the decryption process by using the parameters. Accordingly, the parameter generating device 100 can generate appropriate parameters in the public key cryptosystem using the algebraic torus on the extension field, thereby enabling to realize the securer encryption process.

The secret key generated by the key generation process and used in the decryption process is not limited to (x1, x2, y1, y2, z1, z2) described above. For example, the number of secret keys can be less than (x1, x2, y1, y2, z1, z2).

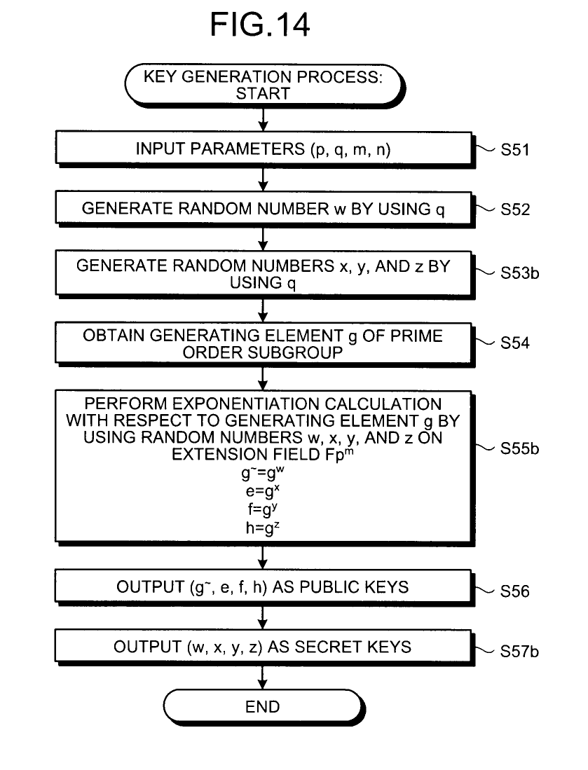

As a modification of the key generation process (a fourth modification of the first embodiment) in this case, there is a process where the number of secret keys to be generated in the key generating device 200 is set four. FIG. 14 is a flowchart of the key-generation process procedure according to the fourth modification of the first embodiment. In the fourth modification, after the parameters (p, q, m, n) are input (Step S51) and the random number w is generated (Step S52) in the same manner as in the key generation process (FIG. 11) in the first embodiment, the random-number generating unit 211 generates random numbers x, y, and z, which are 0≦x, y, z<q, by using the order q of the prime order subgroup G (Step S53b).

The arithmetic unit 212 then performs the exponentiation calculation of equations (11-5) to (11-8) (Step S55b).

g~=g^{w} (11-5)

e=g^{x} (11-6)

f=g^{y} (11-7)

h=g^{z} (11-8)

The output unit 160 outputs calculation results (g~, e, f, h) as the public keys (Step S56), and outputs (w, x, y, z) as the secret keys (Step S57b).

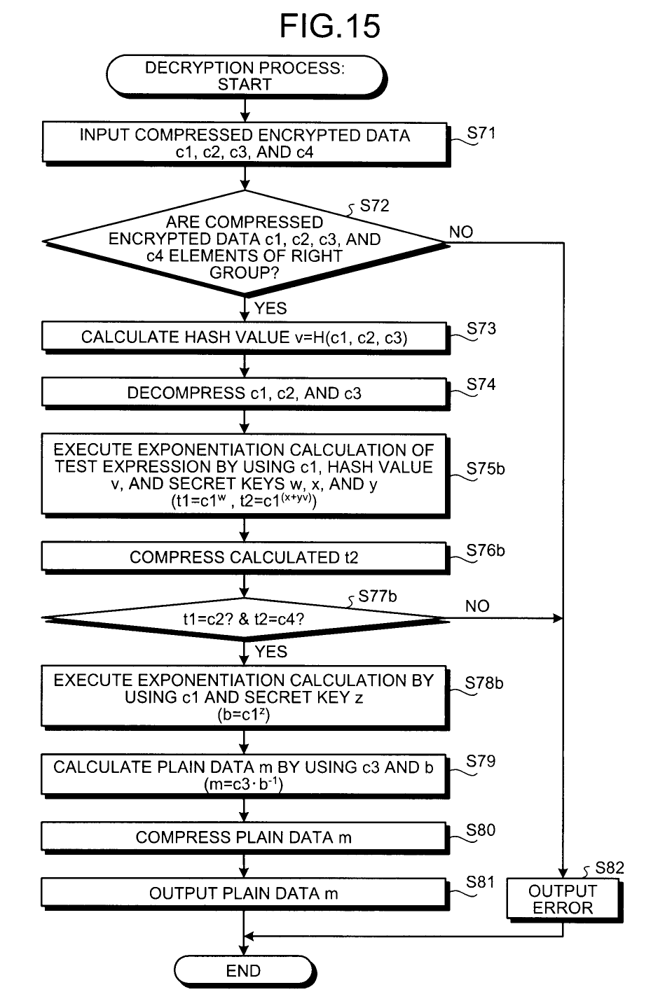

As a modification of the decryption process (a fifth modification of the first embodiment), there is a process where the four secret keys generated in the key generation process in the fourth modification are used. FIG. 15 is a flowchart of the decryption process procedure according to the fifth modification.

The process from input of the compressed encrypted data to decompression of the compressed encrypted data c1, c2, and c3 (Steps S71 to S74) is performed in the same manner as in the decryption process in the first embodiment shown in FIG. 13.

In the fifth modification, when the compressed encrypted data c1 and c3 are decompressed at Step S74b, the arithmetic unit 423 executes the exponentiation calculation of t1=c1^{w}, t2=c1^{(x+yv)} by using the hash value v, the decompressed encrypted data c1, and secret keys w, x, and y (Step S75b). The arithmetic unit 423 then compresses the calculated t1 and t2 (Step S76b).

The second determining unit 422 then determines whether t1 matches c2 of the components of the input encrypted data, and whether t2 matches c4 of the components of the input encrypted data (Step S77b).

When t1 does not match c2, or when t2 does not match c4 (NO at Step S77b), the decryption process is finished. On the other hand, when t1 matches c2, and t2 matches c4 (YES at Step S77b), the arithmetic unit 423 uses c1 and the secret key z to execute the exponentiation calculation of b=c1^{z} (Step S78b).

Compression of the plain data m (Step S80) and output of the plain data m (Step S81) thereafter are performed in the same manner as in the decryption process in the first embodiment shown in FIG. 13.

In the fifth modification, an example in which the number of secret keys is four has been explained; however, the number of secret keys is not limited to four.

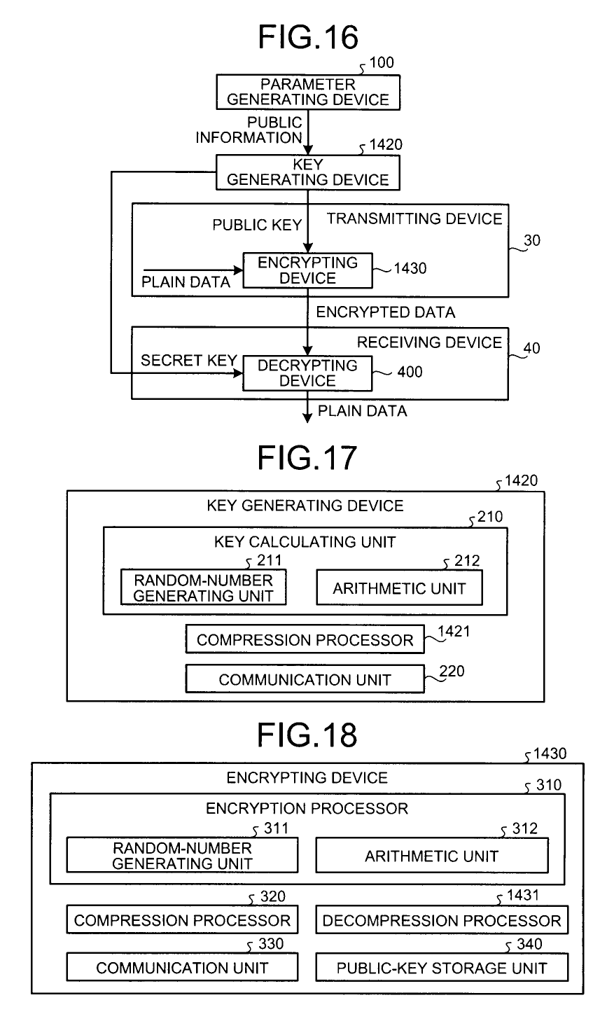

A cryptographic processing system according to a second embodiment of the present invention compresses the public key generated by the key generating device. FIG. 16 is a block diagram of a configuration of the cryptographic processing system according to the second embodiment. As shown in FIG. 16, the cryptographic processing system according to the second embodiment includes the parameter generating device 100, a key generating device 1420, the transmitting device 30, and the receiving device 40. The transmitting device 30 includes an encrypting device 1430, and the receiving device 40 includes the decrypting device 400.

In the second embodiment, the parameter generating device 100 and the decrypting device 400 have the same function and configuration as those in the first embodiment.

The key generating device 1420 uses the parameter (public information) generated by the parameter generating device 100 to generate the public key and the secret key corresponding to the public key, and compresses and outputs the generated public key.

FIG. 17 is a block diagram of a functional configuration of the key generating device 1420 according to the second embodiment. The key generating device 1420 includes, as shown in FIG. 17, the key calculating unit 210, a compression processor 1421, and the communication unit 220. The key calculating unit 210 and the communication unit 220 have the same function and configuration as those in the key generating device 200 of the first embodiment.

The compression processor 1421 performs torus compression with respect to the public keys generated by the key calculating unit 210 according to the operation on the extension field Fp^{m} having the characteristic p and the extension degree m or on the subfield thereof. The compressed public keys are transmitted to the encrypting device 1430 by the communication unit 220.

FIG. 18 is a block diagram of a functional configuration of the encrypting device 1430. The encrypting device 1430 according to the second embodiment includes the encryption processor 310, the compression processor 320, a decompression processor 1431, the communication unit 330, and the public-key storage unit 340. The encryption processor 310, the compression processor 320, the communication unit 330, and the public-key storage unit 340 have the same function and configuration as those in the encrypting device 300 according to the first embodiment.

The decompression processor 1431 performs torus decompression with respect to the torus-compressed public key received by the communication unit 330 from the key generating device 1420, according to the operation on the extension field Fp^{m} having the characteristic p and the extension degree m or on the subfield thereof.

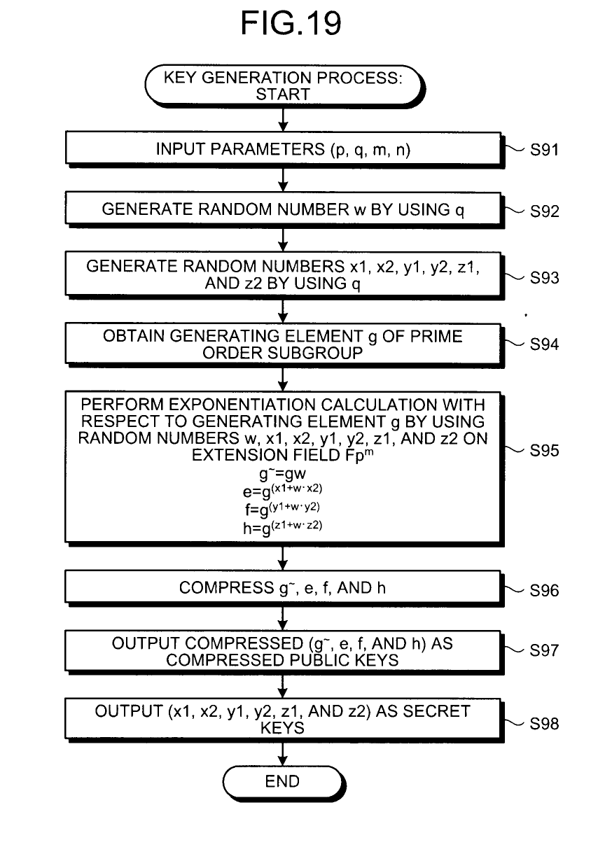

The key generation process in the second embodiment having such a configuration is explained next. FIG. 19 is a flowchart of the key-generation process procedure according to the second embodiment. Processes from input of the parameters (p, q, m, n) to the exponentiation calculation with respect to the generating element g (Steps S91 to S95) are performed in the same manner as in the processes from Steps S51 to S55 in the first embodiment.

When the exponentiation calculation is complete, calculated g~, e, f, and h are subjected to torus compression according to the operation on the extension field Fp^{m} having the characteristic p and the extension degree m or on the subfield thereof, by the compression processor 1421 by using the compression map (Step S96).

The communication unit 220 outputs the compressed (g~, e, f, h) as the compressed public keys (Step S97), and outputs (x1, x2, y1, y2, z1, z2) as the secret keys (Step S98). More specifically, the communication unit 220 transmits the public keys to the encrypting device 1430, and transmits the secret keys to the decrypting device 400.

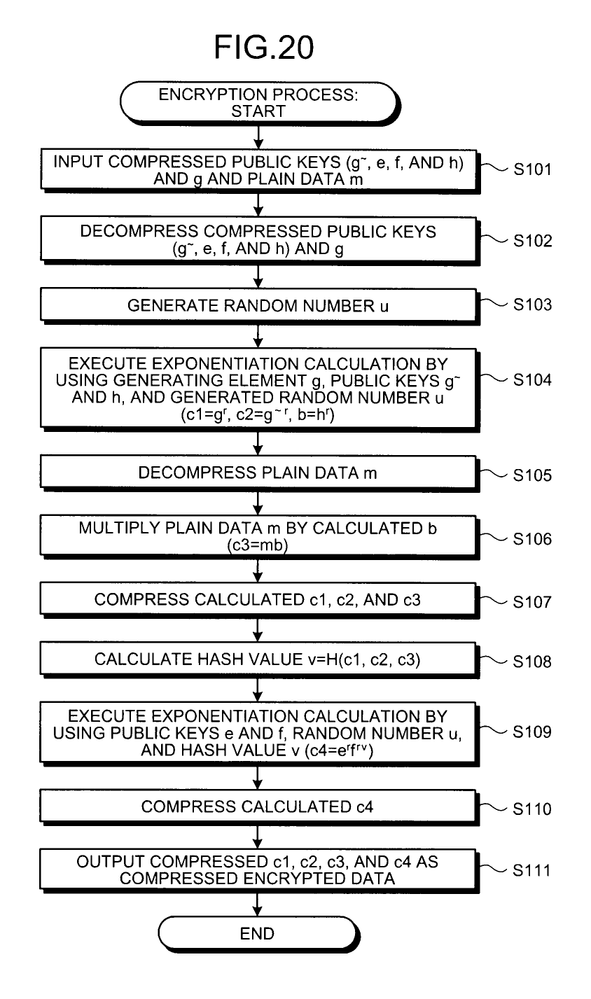

The encryption process performed by the encrypting device 1430 is explained next. FIG. 20 is a flowchart of the encryption process procedure according to the second embodiment.

The communication unit 330 receives (inputs) the generating element g, the compressed public keys (g~, e, f, h), and the plain data m (Step S101). The decompression processor 1431 performs torus decompression with respect to the received compressed public keys (g~, e, f, h) by using the decompression map according to the operation on the extension field Fp^{m} having the characteristic p and the extension degree m or on the subfield thereof (Step S102).

Thereafter, the generation processes of the encrypted data using the decompressed public key are performed in the same manner as in the processes from Steps S62 to S69 in the encryption process in the first embodiment.

In the second embodiment, the operation in the compression process at the time of key generation and the decompression process at the time of encryption process is performed on the extension field Fp^{m} having the characteristic p and the extension degree m or on the subfield thereof. Accordingly, in the second embodiment, appropriate parameters can be generated in the public key cryptosystem using the algebraic torus on the extension field, and a securer encryption process can be realized.

A cryptographic processing system according to a third embodiment of the present invention avoids generation of a parameter in the parameter generating device, when an efficient calculation method of the discrete logarithm problem on torus is efficient with respect to the parameter.

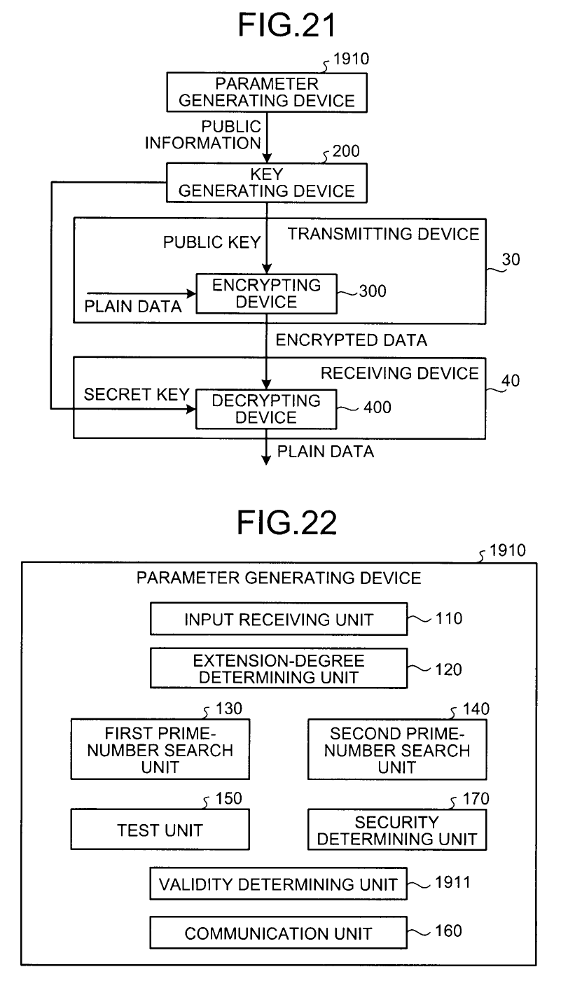

FIG. 21 is a block diagram of a configuration of the cryptographic processing system according to the third embodiment. As shown in FIG. 21, the cryptographic processing system according to the third embodiment includes a parameter generating device 1910, the key generating device 200, the transmitting device 30, and the receiving device 40. The transmitting device 30 includes the encrypting device 300, and the receiving device 40 includes the decrypting device 400.

In the third embodiment, the key generating device 200, the transmitting device 30 (that is, the encrypting device 300), and the receiving device 40 (that is, the decrypting device 400) have the same function and configuration as those in the first embodiment.

FIG. 22 is a block diagram of a functional configuration of the parameter generating device 1910 according to the third embodiment. As shown in FIG. 22, the parameter generating device 1910 mainly includes the input receiving unit 110, the extension-degree determining unit 120, the first prime-number search unit 130, the second prime-number search unit 140, the test unit 150, the security determining unit 170, a validity determining unit 1911, and the output unit 160. The input receiving unit 110, the extension-degree determining unit 120, the first prime-number search unit 130, the second prime-number search unit 140, the test unit 150, the output unit 160, and the security determining unit 170 have the same function and configuration as those in the parameter generating device 100 according to the first embodiment.

The validity determining unit 1911 determines whether the efficient calculation method of the discrete logarithm problem on torus is valid with respect to the parameters (p, q, m, n). This determination is explained below in detail.

There is a Granger-Vercauteren method as a solution of the discrete logarithm problem on torus. The Granger-Vercauteren method is described in “On the discrete logarithm problem on Algebraic Tori” by R. Granger and F. Vercauteren, CRYPTO 2005, LNCS 3621, pp. 66-85, 2005.

Generation of the parameter capable of performing an efficient solution according to the Granger-Vercauteren method needs to be avoided. In the Granger-Vercauteren method, two types of algorithm such as T2 algorithm and T6 algorithm have been proposed.

It is estimated that a calculation amount of the T2 algorithm becomes a value calculated by equation (12-1), and a calculation amount of the T6 algorithm becomes a value calculated by equation (12-2).

O(m! p(m³+m² log p)+m³p²) (12-1)

O((2m)! p(2^{12m}+3^{2m} log p)+m³p²) (12-2)

where O( ) is the order of calculation amount

The T2 algorithm is logically estimated to be subexponential time when n=2 and m!≡p, that is, when equation (13-1) is satisfied. On the other hand, the T6 algorithm is experimentally estimated to be subexponential time when n=6 and (2m)!2^{12m}≡p, that is, when equation (13-2) is satisfied.

m log m≈log p (13-1)

2m log m+12m log 2≈log p (13-2)

Accordingly, generation of the parameter that satisfies the equation (13-1) or (13-2) needs to be avoided.

The validity determining unit 1911 according to the third embodiment determines whether the calculation method efficient in the discrete logarithm problem on torus is valid to the parameters (p, q, m, n) by checking whether these parameters satisfy the condition of the equation (13-1) or (13-2).

The validity determining unit 1911 determines whether a value on a right side and a value on a left side are approximate to each other in respective equations (13-1) and (13-2) by determining whether a difference between the value on the right side and the value on the left side is within a predetermined range.

Because the T2 algorithm can be applied to the parameters (p, q, m, n (=6)) as (p, q, m′ (=3), n′ (=2)), the validity determining unit 1911 performs such application when n=6, to performs determination in the equations (13-1) and (13-2).

In the third embodiment, when all the parameters (p, q, m, n) are generated, the validity determining unit 1911 performs determination in the equations (13-1) and (13-2). When the equations (13-1) and (13-2) are satisfied, the validity determining unit 1911 performs again the determination of the parameters (p, q, m, n).

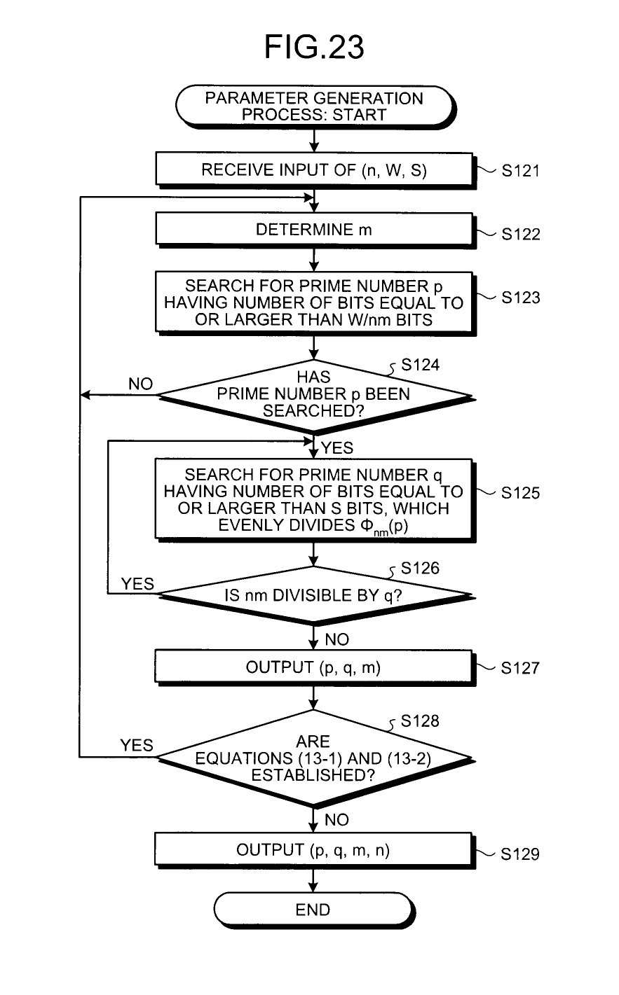

The parameter generation process in the third embodiment is explained next. FIG. 23 is a flowchart of a parameter-generation process procedure according to the third embodiment. The processes from reception of an input of (n, W, S) to output of the parameters (p, q, m, n) (Steps S121 to S127) are performed in the same manner as in the parameter generation process in the first embodiment.

In the third embodiment, at Step S127, when the parameters (p, q, m, n) are output, it is determined that the parameters (p, q, m, n) satisfy the condition of the equation (13-1) or (13-2) (Step S128).

When the parameters (p, q, m, n) satisfy the condition of the equation (13-1) or (13-2) (YES at Step S128), because the calculation method efficient in the discrete logarithm problem on torus is valid to these parameters, the process from Step S122 is repeated again to exclude these parameters.

At Step S128, when the parameters (p, q, m, n) do not satisfy the conditions of the equations (13-1) and (13-2) (NO at Step S128), the calculation method efficient in the discrete logarithm problem on torus is not valid to the parameters. Therefore, the parameters (p, q, m, n) are output to be used for subsequent encryption processes (Step S129).

Thus, in the third embodiment, because parameters, to which the calculation method efficient in the discrete logarithm problem on torus is valid, are excluded at the time of the parameter generation process, a securer and more appropriate parameter generation process can be performed.

Another example is considered for the determination timing of the equations (13-1) and (13-2). In the equations (13-1) and (13-2), it is seen that these two conditional expressions do not depend on the prime number q. Accordingly, in a first modification of the third embodiment, the validity determining unit 1911 determines whether the parameters m, p, and n excluding the prime number q satisfy the condition of the equation (13-1) or (13-2) at the time of finishing the search of the prime number p. Consequently, the parameter generation processing time can be shortened.

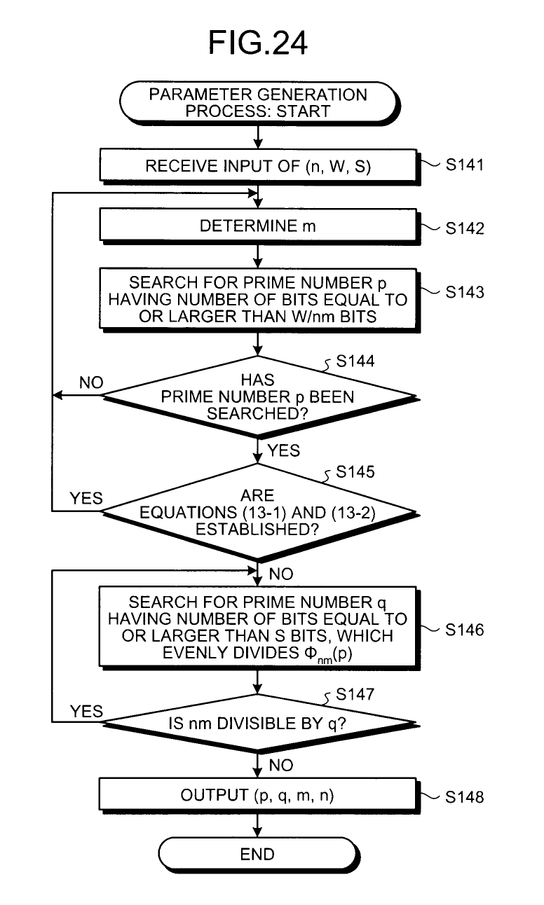

FIG. 24 is a flowchart of a parameter-generation process procedure according to the first modification of the third embodiment. As shown in FIG. 24, when the prime number p is searched by the first prime-number search unit 130 (YES at Step S144), the validity determining unit 1911 uses the extension degree m determined at Step S142, the searched prime number p, and n to determine the condition of the equation (13-1) or (13-2) (Step S145). When the condition of the equation (13-1) or (13-2) is satisfied (YES at Step S145), control returns to Step S142, and repeats determination of m and search of p again.

On the other hand, when the condition of the equation (13-1) or (13-2) is not satisfied (NO at Step S145), the prime number q is searched. Subsequent processes are performed in the same manner as in the parameter generation process in the first embodiment.

In a second modification of the third embodiment, at the time of searching for the prime number p, the validity determining unit 1911 determines the range of the prime number p satisfying the condition of the equation (13-1) or (13-2), and the first prime-number search unit 130 searches for the prime number p in this range.

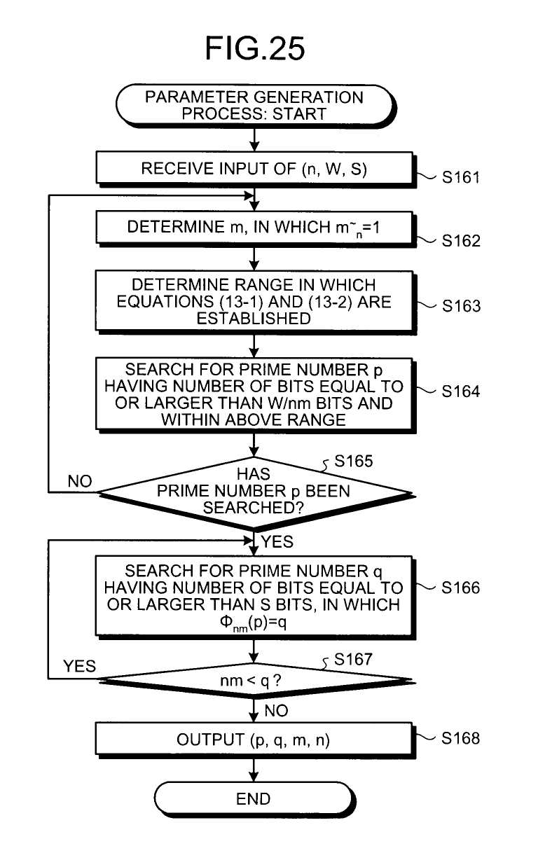

FIG. 25 is a flowchart of a parameter-generation process procedure according to a second modification of the third embodiment. In the second modification, the above process is added to the parameter generation process in the second modification of the first embodiment. That is, after m in which m~ₙ=1 has been determined (Step S162), the validity determining unit 1911 determines the range of the prime number p that satisfies the condition of the equation (13-1) or (13-2) (Step S163). The first prime-number search unit 130 searches for the prime number p having the number of bits equal to or larger than W/nm and within the range determined at Step S162 (Step S164). Subsequent processes are the same as in the parameter generation process in the second modification of the first embodiment.

In a third modification of the third embodiment, at the time of searching for the prime number p, the extension-degree determining unit 120 determines m satisfying the condition of the equation (13-1) or (13-2).

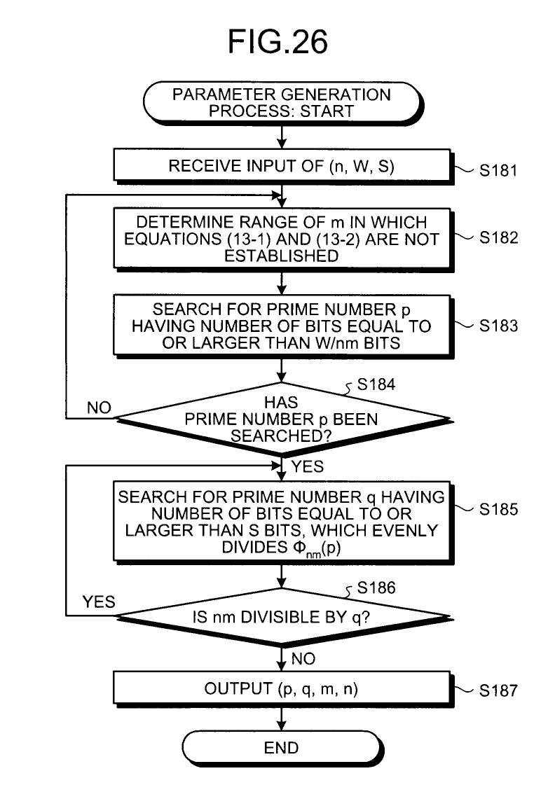

FIG. 26 is a flowchart of a parameter-generation process procedure according to the third modification of the third embodiment. The input receiving unit 110 receives an input of (n, W, S) (Step S181). The validity determining unit 1911 sets the range of m in which the condition of the equation (13-1) or (13-2) is not satisfied, and the extension-degree determining unit 120 determines the extension degree m in this range (Step S182).

For example, m satisfying equation (14-1) is avoided for the T2 algorithm, and m satisfying equation (14-2) is avoided for the T6 algorithm.

3m×log(3m)≈log(p) (14-1)

2m×log(m)+12m≈log(p) (14-2)

For example, when there is a difference larger than 10 times or more between the right side and the left side, m is adopted. Because a lower limit of log(p) is W/nm, the right side of the equations (14-1) and (14-2) can be W/nm. As explained in the first embodiment, when the modulus polynomials of the m-th, cubic, and quadratic extensions are respectively z^{m}−s, y³−w, and x²+1, m=3^{e} based on the condition of 1) and 5) of the sufficient conditions for these modulus polynomials being irreducible on the respective fields Fp and Fp^{m}, and Fp^{3m}. Accordingly, W/nm, 3m×log(3m), 2m×log(m)+12m are calculated for a case of m=3, 9, 27, 81, 243, 729, . . . . Further, when the conditions of the equations (14-1) and (14-2) are avoided, m=27, 81, and 243 can be obtained. For m equal to or larger than 729, because W/nm<1, there is no p with the size 6m×log(p) of the finite field being about W, and therefore m in this range is off the subject.

In another example, as explained in the first embodiment, when the modulus polynomials of the m-th, cubic, and quadratic extensions are, respectively, z^{m}−s, y³−w, and x²−δ, m=2^{a}3^{b} based on condition 6′) of the necessary and sufficient conditions for these modulus polynomials being irreducible on the respective fields Fp, Fp^{m}, and Fp^{3m}. Accordingly, when the conditions of the equations (14-1) and (14-2) are avoided, m equal to or smaller than 16 is excluded. For m equal to or larger than 384, because W/nm<1, there is no p with the size 6m×log(p) of the finite field being about W, and therefore m in this range is off the subject.

A cryptographic processing system according to a fourth embodiment of the present invention includes a security determining device that determines security of the parameter generated by the parameter generating device 100.

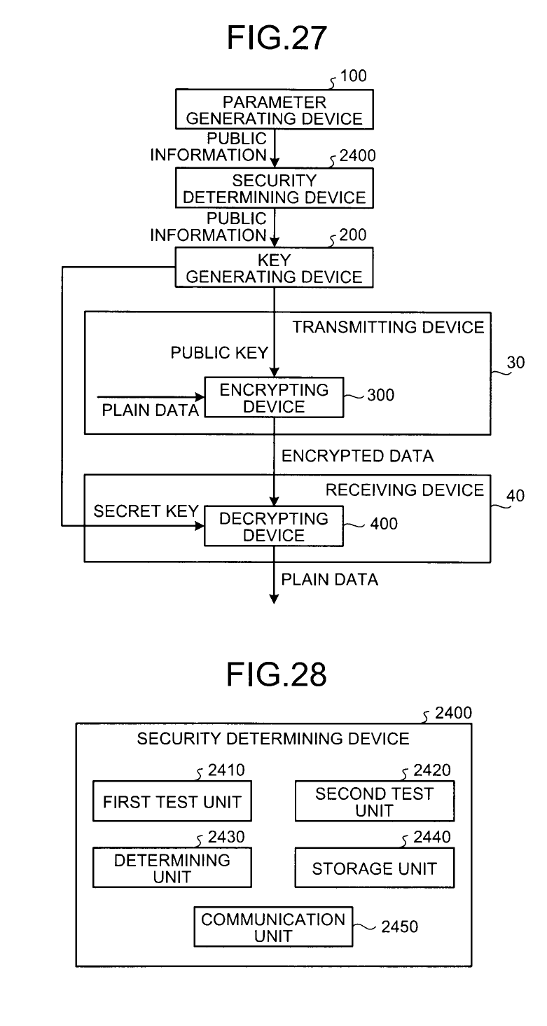

FIG. 27 is a block diagram of a configuration of the cryptographic processing system according to the fourth embodiment. As shown in FIG. 27, the cryptographic processing system according to the fourth embodiment includes the parameter generating device 100, the key generating device 200, a security determining device 2400, the transmitting device 30, and the receiving device 40. The transmitting device 30 includes the encrypting device 300, and the receiving device 40 includes the decrypting device 400.

In the fourth embodiment, the parameter generating device 100, the key generating device 200, the transmitting device 30 (that is, the encrypting device 300), and the receiving device 40 (that is, the decrypting device 400) have the same function and configuration as those in the first embodiment.

FIG. 28 is a block diagram of a functional configuration of the security determining device 2400. The security determining device 2400 according to the fourth embodiment mainly includes a first test unit 2410, a second test unit 2420, a determining unit 2430, a storage unit 2440, and a communication unit 2450.

When a group of the prime order q is embedded in the extension field of the characteristic p, if the minimum extension degree is expressed as ord(q, p), the condition to be satisfied by the parameter is rewritten as ord(q, p)=nm. It is determined whether the parameter satisfies this condition by determining whether the parameters (p, q, m, n) satisfy the two conditions of the equations (9-1) and (9-2).

When there is a plurality of subtori of the algebraic torus, it is assumed that the order of the subgroup to be used for the cryptography is fixed by q. The condition 1 of the equation (9-1) means that the subgroup included in the subtorus corresponding to the largest extension field (not included in the subfield thereof) is used for the cryptography. The condition 2 of the equation (9-2) means that the subgroup used for the cryptography is not included in the subtorus corresponding to a smaller extension field. That is, the condition 2 of the equation (9-2) means that the subfield used for the cryptography is included in only one subtorus of the subtori.

Accordingly, the first test unit 2410 determines whether the parameter satisfies the equation (9-1) and determines whether the cyclotomic polynomial Φₙₘ(p) is divisible by q, thereby checking whether the prime order subgroup G is included in the algebraic torus of the degree nm of the subgroups of the algebraic torus T.

The second test unit 2420 determines whether the parameter satisfies the equation (9-2) and determines whether the multiplication value nm is divisible by q, thereby checking whether the prime order subgroup G is included in only one subgroup of the subgroups of the algebraic torus T.

When the test result of the first test unit 2410 is positive, and the test result of the second test unit 2420 is positive, the determining unit 2430 determines that the parameters (p, q, m, n) have the same security level as that of the extension fields of the characteristic p and the extension degree nm.

The communication unit 2450 receives the parameters (p, q, m, n) and transmits the determination result of the security.

The storage unit 2440 temporarily stores the determination result and the like.

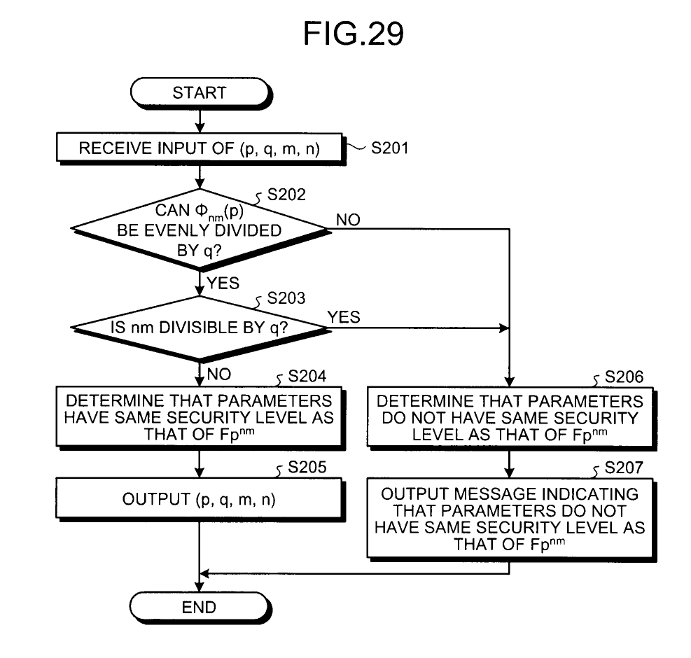

A security determination process performed by the security determining device 2400 is explained next. FIG. 29 is a flowchart of a security-determination process procedure according to the fourth embodiment.

The communication unit 2450 receives and accepts the parameters (p, q, m, n) generated by the parameter generating device 100 (Step S201). The first test unit 2410 checks whether the cyclotomic polynomial Φₙₘ(p) is divisible by q (Step S202). When the cyclotomic polynomial is not divisible (NO at Step S202), the determining unit 2430 determines that the parameters (p, q, m, n) do not have the same security level as that of the extension field Fp^{nm} (the extension field of the characteristic p and the extension degree nm) (Step S206), and the communication unit 2450 outputs a message indicating that the parameters do not have the same security level (Step S207).

On the other hand, at Step S202, when the cyclotomic polynomial Φₙₘ(p) is divisible by q (YES at Step S202), the second test unit 2420 checks whether nm is divisible by q (Step S203). When nm is divisible by q (YES at Step S203), the determining unit 2430 determines that the parameters (p, q, m, n) do not have the same security level as that of the extension field Fp^{nm} (Step S206), and the communication unit 2450 outputs a message indicating that the parameters do not have the same security level (Step S207).

On the other hand, at Step S203, when nm is not divisible by q (NO at Step S203), the determining unit 2430 determines that the parameters (p, q, m, n) have the same security level as that of the extension field Fp^{nm} (Step S204), and the communication unit 2450 outputs the parameters (p, q, m, n) (Step S205).

Thus, in the fourth embodiment, because it is determined whether the obtained parameters satisfy the condition of the equation of (9-1) or (9-2), decrease in the security level can be prevented beforehand.

Even if the condition 2 in the equation (9-2) is not satisfied, as far as the equation (10) is satisfied for every d of d|nm and d<nm, the parameters have the security.

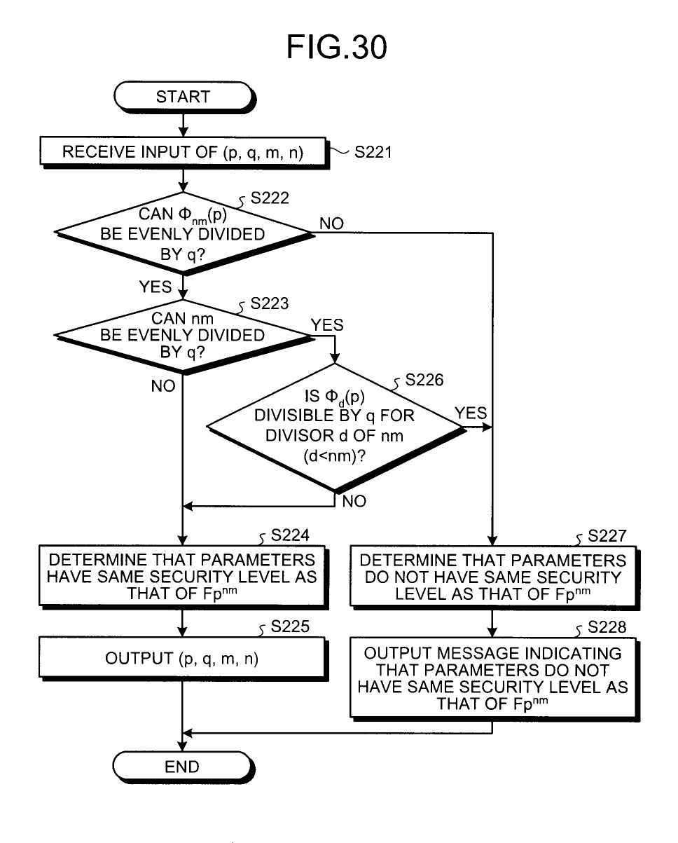

FIG. 30 is a flowchart of the security-determination process procedure according to a first modification of the fourth embodiment. Reception of an input of the parameters (p, q, m, n) (Step S221), determination of whether the cyclotomic polynomial Φₙₘ(p) is divisible by q (Step S222), and determination of whether nm is divisible by q (Step S223) are performed in the same manner as in the process shown in FIG. 29 in the fourth embodiment (Steps S201, S202, and S203). In the first modification, at Step S223, when nm is divisible by q and the parameters do not satisfy the condition 2 of the equation (9-2) (YES at Step S223), it is checked whether the equation (10) is satisfied for every d of d|nm and d<nm. That is, it is checked whether Φ_{d}(p) is divisible by q for the divisor d of nm (Step S226). When Φ_{d}(p) is not divisible by q (NO at Step S226), it is determined that the equation (10) is satisfied and it is determined that the parameters (p, q, m, n) have the same security level as that of the extension field Fp^{nm} (Step S224), and the communication unit 2450 outputs the parameters (p, q, m, n) (Step S225).

On the other hand, at Step S226, when Φ_{d}(p) is divisible by q for the divisor d of nm (YES at Step S226), it is determined that the equation (10) is not satisfied. The determining unit 2430 determines that the parameters (p, q, m, n) do not have the same security level as that of the extension field Fp^{nm} (Step S227), and the communication unit 2450 outputs a message indicating that the parameters do not have the same security level (Step S228).

As a second modification of the fourth embodiment, even if the condition 1 in the equation (9-1) and the condition 2 in the equation (9-2) are not satisfied, it can be checked in which extension field the prime order subgroup G, in which the cryptosystem is defined, is included, thereby outputting how much degree the security level decreases.

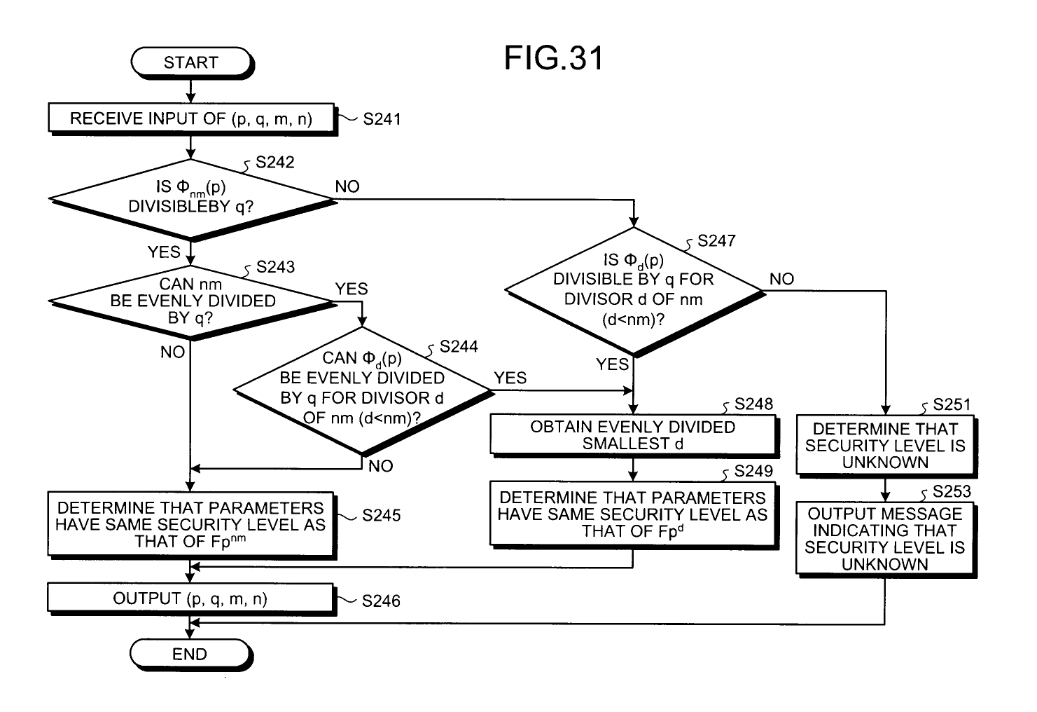

FIG. 31 is a flowchart of a security-determination process procedure according to a second modification of the fourth embodiment. Input of the parameters (p, q, m, n) (Step S241), determination of whether the cyclotomic polynomial Φₙₘ(p) is divisible by q (Step S242), determination of whether nm is divisible by q (Step S243), and determination of whether the polynomial Φ_{d}(p) is divisible by q for the divisor d of nm (Step S244) are performed in the same manner as in the process (Steps S221, S222, S223 and S224) shown in FIG. 30 in the first modification of the fourth embodiment.

In the second modification, at Step S242, when the cyclotomic polynomial Φₙₘ(p) is not divisible by q (NO at Step S242) and the condition 1 of the equation (9-1) is not satisfied, it is checked whether Φ_{d}(p) is divisible by q for the divisor d of nm (Step S247). When Φ_{d}(p) is divisible by q for the divisor d of nm (YES at Step S247), it is determined that the equation (10) is not satisfied, to obtain the evenly divided smallest d (Step S248), and it is determined that the parameters have the same security level as that of the extension field Fp^{d} (Step S249).

On the other hand, at Step S247, when Φ_{d}(p) is not divisible by q for the divisor d of nm (NO at Step S247), the determining unit 2430 determines that the security level in unknown (Step S251), and the communication unit 2450 outputs a message indicating that the security level is unknown (Step S253).

Further, at Step S243, even if nm is divisible by q and the condition 2 of the equation (9-2) is not satisfied (YES at Step S243), it is checked whether Φ_{d}(p) is divisible by q for the divisor d of nm (Step S244). When Φ_{d}(p) is divisible by q for the divisor d of nm (YES at Step S244), it is determined that the equation (10) is not satisfied, to obtain the evenly divided smallest d (Step S248), and it is determined that the parameters have the same security level as that of the extension field Fp^{d} (Step S249). Accordingly, the security level can be determined.

Meanwhile, at Step S244, when nm is not divisible by q (NO at Step S244), the same processes as those shown in FIG. 30 (Steps S244 and S225) in the first modification of the fourth embodiment are performed (Steps S245 and S246).

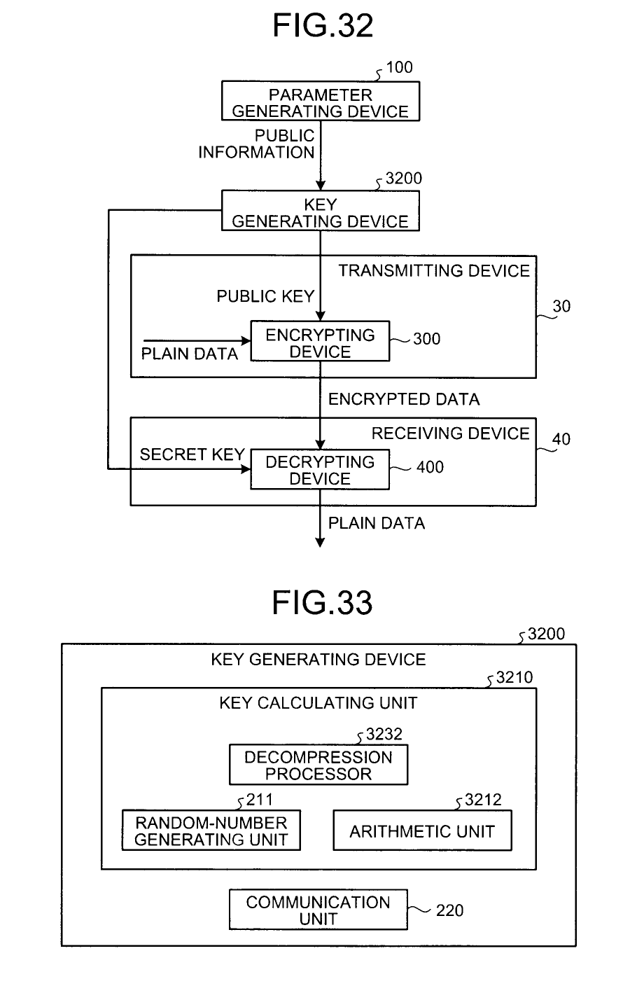

A cryptographic processing system according to a fifth embodiment of the present invention improves the efficiency of processing of a public-key calculating unit in the key generating device. FIG. 32 is a block diagram of a configuration of the cryptographic processing system according to the fifth embodiment. As shown in FIG. 32, the cryptographic processing system includes the parameter generating device 100, a key generating device 3200, the transmitting device 30, and the receiving device 40. The transmitting device 30 includes the encrypting device 300, and the receiving device 40 includes the decrypting device 400.

In the fifth embodiment, the parameter generating device 100, the transmitting device 30 (that is, the encrypting device 300), and the receiving device 40 (that is, the decrypting device 400) have the same function and the configuration as those in the first or second embodiment.

FIG. 33 is a block diagram of a functional configuration of the key generating device 3200 according to the fifth embodiment. As shown in FIG. 33, the key generating device 3200 mainly includes a key calculating unit 3210 and the communication unit 220. The function of the communication unit 220 is the same as that of the first embodiment.

The key calculating unit 3210 inputs the parameters (p, q, m, n) generated by the parameter generating device 100 to generate the public key and the secret key in the same manner as in the first embodiment. The key calculating unit 3210 includes the random-number generating unit 211, a decompression processor 3232, and an arithmetic unit 3212. The function of the random-number generating unit 211 is the same as that of the first embodiment.

The arithmetic unit 3212 generates the secret key as in the first embodiment and further obtains the generating element g of the prime order subgroup G. At this time, the arithmetic unit 3212 obtains the generating element g in a compressed representation. When the generating element g is to be generated, if the generating element is obtained in the compressed representation, probability of generating the generating element not included in the prime order subgroup G decreases, thereby enabling to improve generation efficiency of the generating element. Particularly, in a case that the prime order subgroup G is the algebraic torus T of the prime order, if an element of the extension field Fp^{m}, in which the algebraic torus is defined, is generated, the generating element g included in the prime order subgroup G at all times can be generated. Also in such a case that the generating element g is stored in a memory and the generating element g is read from the memory, a memory capacity of the memory can be reduced in a case that the generating element g is stored in the memory or the like in the compressed representation, as compared to a case that the uncompressed generating element g is stored.

The decompression processor 3232 performs torus decompression with respect to the generating element g in the compressed representation obtained by the arithmetic unit 3212 before performing exponentiation and multiplication by the arithmetic unit 3212. The arithmetic unit 3212 performs exponentiation and multiplication by using the generated random number on the extension field having the characteristic p and the extension degree m or on the subfield thereof with respect to the generating element g torus-decompressed by the decompression processor 3232, to obtain the public key, as in the first embodiment.

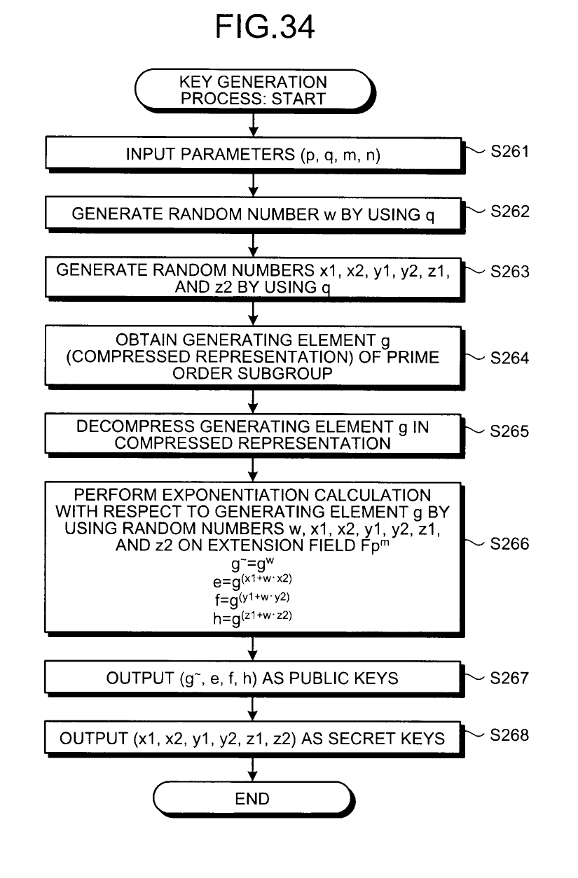

The key generation process performed by the key generating device 3200 is explained next. FIG. 34 is a flowchart of a key-generation process procedure according to the fifth embodiment.

The process from input of the parameters (p, q, m, n) to the generation of the random numbers x1, x2, y1, y2, z1, and z2 (Steps S261 to S263) is performed first in the same manner as in the key generation process (Steps S51 to S53) in the first embodiment.

When the random numbers x1, x2, y1, y2, z1, and z2 are generated, the arithmetic unit 3212 obtains the generating element g of the prime order subgroup G in the compressed representation (Step S264). The decompression processor 3232 performs torus decompression with respect to the generating element g in the compressed representation before performing exponentiation and multiplication (Step S265).

Subsequent processes of generation and output of the public key and output of the secret key (Steps S266 to S268) are performed in the same manner as in the key generation process (Steps S55 to S57) in the first embodiment.

In the fifth embodiment, the key generating device 3200 obtains the generating element g in the compressed representation to perform torus decompression with respect to the generating element g (compressed representation) obtained by the decompression processor 3232, thereby enabling to efficiently perform processes for obtaining the generating element g, as compared with the key generating device which does not have the decompression processor 3232 that checks the order at the time of generating the generating element g and stores the element of the algebraic torus in an decompressed representation.

The parameter generating device, the key generating device, the encrypting device, and the decrypting device according to the first to fifth embodiments include a controller such as a central processing unit (CPU), a memory such as a read only memory (ROM) and a random access memory (RAM), an external memory such as a hard disk drive (HDD) or a compact disk (CD) drive, a display device, and an input device such as a key board and a mouse, and have a hardware configuration using a normal computer.

Further, each program executed by the parameter generating device, the key generating device, the encrypting device, and the decrypting device can be recorded on a computer-readable recording medium such as a CD-ROM, a flexible disk (FD), a CD recordable (CD-R), or a digital versatile disk (DVD) in a file of an installable or executable format, and provided as a computer program product.

Each program executed by the parameter generating device, the key generating device, the encrypting device, and the decrypting device can be configured to be previously installed in a ROM or the like and provided.

Each program executed by the parameter generating device, the key generating device, the encrypting device, and the decrypting device according to the first to fifth embodiments has a module configuration including the above units. As practical hardware, a CPU (processor) reads the program and executes the decrypting program, to load the units in a maim memory, so that these units are generated in the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A parameter generating device comprising:
an input receiving unit that receives an input of a degree n of an algebraic torus T including a group G in which a cryptosystem used in a torus-compressed public key cryptosystem is defined, a size W of a finite field F defining security, and a size S of the group G;
an extension-degree determining unit that determines an extension degree m of a finite field Fp^{m} in which the algebraic torus T is defined;
a first prime-number search unit that searches for a prime number p having number of bits based on the size W of the finite field F, the degree n of the algebraic torus T, and the extension degree m;
a second prime-number search unit that searches for a prime number q having number of bits defined based on the size S of the group G, which evenly divides a cyclotomic polynomial Φₙₘ(p);
a test unit that checks whether a multiplication value nm obtained by multiplying the degree n of the algebraic torus T by the extension degree m of the finite field Fp^{m} is divisible by the prime number q;
a security determining unit that determines that the cryptosystem is secure when the multiplication value nm is not divisible by the prime number q; and
an output unit that outputs parameters (p, q, n, m) including the prime number p, the prime number q, the degree n of the algebraic torus T, and the extension degree m, when it is determined that the cryptosystem is secure.

2. The device according to claim 1, wherein the first prime-number search unit searches for the prime number p having number of bits equal to or larger than W/nm, and the second prime-number search unit searches for the prime number q having number of bits equal to or larger than S, which evenly divides the cyclotomic polynomial Φₙₘ(p).

3. The device according to claim 1, wherein the group G uses a prime order torus T, and
the second prime-number search unit searches for the prime number q satisfying Φₙ(p^{m})=Φₙₘ(p)=q, and having the number of bits equal to or larger than S.

4. The device according to claim 1, wherein the group G uses a prime order torus T,
the extension-degree determining unit determines the extension degree m by calculating a product of powers of prime factors having the degree n of the algebraic torus T, and
the second prime-number search unit searches for the prime number q satisfying Φₙ(p^{m})=q, and having the number of bits equal to or larger than S.

5. The device according to claim 1, wherein the group G uses a prime order torus T,
when the multiplication value nm is divisible by the prime number q, the test unit further adopts each divisor d of the multiplication value nm (d<nm), thereby checking whether a cyclotomic polynomial Φ_{d}(p) is divisible by q, and
when the cyclotomic polynomial Φ_{d}(p) is not divisible by q for any of the adopted divisor d, the output unit outputs the parameters (p, q, m).

6. The device according to claim 1, wherein the test unit checks whether nm is smaller than the prime number q, when number of bits of the prime number p is larger than a predetermined number of bits, and
when the multiplication value nm is smaller than the prime number q, the output unit determines that the cryptosystem is secure, and outputs the parameters (p, q, n, m).

7. The device according to claim 1, further comprising a validity determining unit that determines whether the prime number p, the degree n of the algebraic torus T, and the extension degree m of the finite field Fp^{m} satisfy a condition 1 below when the degree n of the algebraic torus T is divisible by 2, and determines whether the prime number p, the degree n of the algebraic torus T, and the extension degree m of the finite field Fp^{m} satisfy a condition 2 below when the degree n of the algebraic torus T is divisible by 6, thereby determining whether a calculation method of a discrete logarithm problem on the algebraic torus T is valid, wherein
the condition 1 is m′ log m′≡log p, where m′=nm/2,
the condition 2 is 2m′ log m′+12m′ log 2≡log p, where m′=nm/6.

8. The device according to claim 7, wherein when it is determined that the calculation method of the discrete logarithm problem on torus is not valid, the output unit outputs the parameters (p, q, n, m).

9. The device according to claim 7, wherein after the first prime-number search unit has searched for the prime number p, the validity determining unit determines whether the calculation method of the discrete logarithm problem on the algebraic torus T is valid, and
when it is determined that the calculation method of the discrete logarithm problem on torus is not valid, the second prime-number search unit searches for the prime number q.

10. The device according to claim 7, wherein when the validity determining unit determines that the condition 1 or the condition 2 is not satisfied, the first prime-number search unit searches for the prime number p having number of bits based on the size W of the finite field F, the degree n of the algebraic torus T, and the extension degree m.

11. The device according to claim 7, wherein the extension-degree determining unit determines the extension degree m of the finite field Fp^{m}, which has been determined not to satisfy the condition 1 or the condition 2 by the validity determining unit.

12. A cryptographic processing system comprising a parameter generating device, a key generating device, an encrypting device, and a decrypting device connected to the encrypting device by a network, wherein
the parameter generating device includes:
a first input-receiving unit that receives an input of a degree n of an algebraic torus T including a group G in which a cryptosystem used in a torus-compressed public key cryptosystem is defined, a size W of a finite field F defining security, and a size S of the group G;
an extension-degree determining unit that determines an extension degree m of a finite field Fp^{m} in which the algebraic torus T is defined;
a first prime-number search unit that searches for a prime number p having number of bits based on the size W of the finite field F, the degree n of the algebraic torus T, and the extension degree m;
a second prime-number search unit that searches for a prime number q having number of bits defined based on the size S of the group G, which evenly divides a cyclotomic polynomial Φₙₘ(p);
a test unit that checks whether a multiplication value nm obtained by multiplying the degree n of the algebraic torus T by the extension degree m of the finite field Fp^{m} is divisible by the prime number q;
a first security-determining unit that determines that the cryptosystem is secure when the multiplication value nm is not divisible by the prime number q; and
a first output unit that outputs parameters (p, q, n, m) including the prime number p, the prime number q, the degree n of the algebraic torus T, and the extension degree m, when it is determined that the cryptosystem is secure, the key generating device includes:
a second input-receiving unit that receives an input of the parameters (p, q, n, m);
a public-key calculating unit that designates the prime number q as an order of the group G and the prime number p as a characteristic of the finite field F, thereby calculating a public key by a combination of operations on the finite field Fp^{m} having the characteristic p and the extension degree m or on a subfield thereof; and
a second output unit that outputs the public key,
the encrypting device includes:
a third input-receiving unit that receives an input of the public key and a plain data;
an encryption processor that performs an encryption process using the public key with respect to the plain data, by a combination of operations on the finite field Fp^{m} having the characteristic p and the extension degree m or on the subfield thereof, to obtain encrypted data; and
a transmitting unit that transmits the encrypted data to the decrypting device, and
the decrypting device includes:
a storage unit that stores a secret key;
a receiving unit that receives the encrypted data;
a decryption processor that performs a decryption process using the secret key with respect to the encrypted data by a combination of operations on the finite field Fp^{m} having the characteristic p and the extension degree m or on the subfield thereof, to obtain the plain data; and
a fourth output unit that outputs the plain data.

13. The system according to claim 12, wherein the torus-compressed public key cryptosystem is a cryptosystem based on a discrete logarithm problem, and
the public-key calculating unit in the key generating device includes:
a first random-number generating unit that generates a random number, whose range is limited by the order q of the group G; and
a first arithmetic unit that obtains the public key by performing exponentiation and multiplication using a generated random number or an exponent calculated by using the random number, with respect to a generating element g of the group G, according to the combination of operations on the finite field Fp^{m} having the characteristic p and the extension degree m or on the subfield thereof.

14. The system according to claim 13, wherein the key generating device further includes a first compression processor that performs torus compression with respect to the public key, according to the combination of operations on the finite field Fp^{m} having the characteristic p and the extension degree m or on the subfield thereof, and
the second output unit outputs the public key torus-compressed by the first compression processor as the public key.

15. The system according to claim 13, wherein the key generating device includes a first decompression processor that performs torus decompression with respect to a torus-compressed generating element g, and
the first arithmetic unit performs exponentiation and multiplication using the generated random number or the exponent calculated by using the random number, with respect to the generating element g torus-decompressed by the first decompression processor, according to the combination of operations on the finite field Fp^{m} having the characteristic p and the extension degree m or on the subfield thereof, thereby obtaining the public key.

16. The system according to claim 12, wherein the torus-compressed public key cryptosystem is a cryptosystem based on a discrete logarithm problem, and
the encryption processor in the encrypting device includes:
a second random-number generating unit that generates a random number, whose range is limited by the order q of the group G; and
a second arithmetic unit that performs first exponentiation using the random number with respect to a generating element g and the public key on the finite field Fp^{nm} having the characteristic p and the extension degree m or on the subfield thereof, multiplies the plain data by a result of first exponentiation to obtain a hash value of a multiplied result and the result of the first exponentiation, and performs second exponentiation using the hash value and the random number with respect to the public key, thereby obtaining the first exponentiation result and the second exponentiation result as the encrypted data.

17. The system according to claim 16, wherein the encrypting device further includes a second compression processor that performs torus compression with respect to the encrypted data according to the combination of operations on the finite field Fp^{m} having the characteristic p and the extension degree m or on the subfield thereof.

18. The system according to claim 16, wherein the encrypting device further includes a second decompression processor that performs torus decompression with respect to a torus-compressed public key according to the combination of operations on the finite field Fp^{m} having the characteristic p and the extension degree m or on the subfield thereof.

19. The cryptographic processing system according to claim 12, wherein the torus-compressed public key cryptosystem is a cryptosystem based on a discrete logarithm problem, and
the decryption processor in the decrypting device includes:
a first determining unit that checks whether the encrypted data is an element of the group G, and when the encrypted data is the element of the group G, determines that the encrypted data is valid;
a second determining unit that obtains a hash value of the encrypted data, performs exponentiation and multiplication with respect to an element of the encrypted data by using the hash value and the secret key, and when a result thereof matches a predetermined test expression, determines that the encrypted data is valid; and
a third arithmetic unit that performs exponentiation and multiplication with respect to an element of the encrypted data according to the combination of operations on the finite field Fp^{m} having the characteristic p and the extension degree m or on the subfield thereof, to obtain an inverse element value, and multiplies the inverse element value by the element of the encrypted data to obtain the plain data, and wherein
when it is determined that the encrypted data is valid by the first and second determining units, the fourth output unit outputs the plain data.

20. The cryptographic processing system according to claim 19, wherein
the receiving unit in the decrypting device receives torus-compressed encrypted data,
the first determining unit in the decrypting device checks whether the torus-compressed encrypted data is the element of the group G, and when the encrypted data is the element of the group G, determines that the encrypted data is valid, and
the decrypting device further includes a third decompression processor that performs torus decompression with respect to the torus-compressed encrypted data according to the combination of operations on the finite field Fp^{m} having the characteristic p and the extension degree m or on the subfield thereof.

21. The system according to claim 19, wherein the decrypting device further includes a third compression processor that performs torus compression with respect to the plain data, according to the combination of operations on the finite field Fp^{m} having the characteristic p and the extension degree m or on the subfield thereof, and
the fourth output unit outputs the plain data torus-compressed by the third compression processor as the plain data.

22. The cryptographic processing system according to claim 12, further comprising a security determining device that determines security of the cryptosystem, wherein
the security determining device includes:
a fifth input receiving unit that receives an input of parameters (p, q, m, n) output from the parameter generating device;
a first test unit that checks whether the group G is included in an algebraic torus T^{nm} having the degree nm, of subgroups of the algebraic torus T, by determining whether the cyclotomic polynomial Φₙₘ(p) is divisible by q;
a second test unit that checks whether the group G is included in only one subgroup of the subgroups of the algebraic torus T, by determining whether the multiplication value nm is divisible by q;
a second security-determining unit that determines that the parameters (p, q, m, n) have a same security level as that of an extension field Fp^{nm} having the characteristic p and the extension degree nm, when a test result by the first test unit is positive and a test result by the second test unit is positive; and
a fifth output unit that outputs a determination result obtained by the second security-determining unit.

23. The cryptographic processing system according to claim 22, wherein when the multiplication value nm is divisible by the prime number q, the second test unit adopts each divisor d of the multiplication value nm (d<nm) to check whether a cyclotomic polynomial Φ_{d}(p) is divisible by q, and
when the test result by the first test unit is positive and the smallest divisor d by the second test unit is nm, the second security-determining unit determines that the parameters (p, q, m, n) have a same security level as that of the extension field Fp^{nm} having the characteristic p and the extension degree nm.

24. The cryptographic processing system according to claim 23, further comprising an extension-degree storage unit that stores the smallest d, wherein
the second security-determining unit obtains d stored in the extension-degree storage unit, and determines that the parameters (p, q, m, n) have a same security level as that of the extension field Fp^{nm} having the characteristic p and the extension degree nm.
